(19) United States
(12) Patent Application Publication
(10) Pub. No.: US 2026/0222632 A1
(43) Pub. Date: Jul. 30, 2026

(54) ANALYSIS FOR STORAGE DECISIONS OF MEDIA CONTENT IN A CONTENT CACHE

(71) Applicant: VIASAT, INC., Carlsbad, CA (US)

(72) Inventors: Devin R. TOTH, Carlsbad, CA (US); Daniel M. NEWMAN, Carlsbad, CA (US)

(21) Appl. No.: 19/572,766

(22) Filed: Mar. 19, 2026

Related U.S. Application Data
(63) Continuation of application No. PCT/US2024/048239, filed on Sep. 24, 2024.
(60) Provisional application No. 63/585,201, filed on Sep. 25, 2023.

(51) Int. Cl. H04N 21/231; H04N 21/2183; H04N 21/442

(52) U.S. Cl. CPC H04N 21/23106; H04N 21/2183; H04N 21/44213

(57) ABSTRACT

Storage decisions for a content cache determined for upgrades of renditions of a media object based on storage utility values for the renditions. The storage utility values for the renditions may be determined based on expected actions determined using delivery utility of renditions in a plurality of model scenarios. The storage values may also consider the behavior probability for user behaviors of the model scenarios. The rendition upgrade value for the rendition upgrades may be determined as the incremental storage value for a rendition upgrade per an incremental size for a rendition upgrade. By making storage decisions based on rendition upgrade values, the value of renditions stored in the content cache may be optimized.

### BACKGROUND

Digital media objects may be delivered over a network to facilitate rendering a media object at a user device. For example, many users now obtain media objects for playback via network communications either in conjunction with broadcast television or as an alternative thereto. In some instances, content caches containing data for one or more media objects may be maintained to improve media object delivery. For example, a user content cache may be maintained at a user device. Media objects may be prepositioned in the user content cache for later consumption by a user. By prepositioning media content in a user’s content cache, subsequent requests for media objects may be served by delivering locally stored data for the media object, thus reducing network utilization and providing an enhanced user experience.

### SUMMARY

In some aspects, the techniques described herein relate to a method for performing storage decisions for a content cache, including: identifying one or more renditions of at least one media element of one or more media objects; determining a storage utility for the one or more renditions; calculating a rendition upgrade value for available rendition upgrades, wherein the rendition upgrade value is based on an incremental storage utility of a rendition upgrade and an incremental storage size of the rendition upgrade; sorting a listing of one or more available rendition upgrades by the rendition upgrade value; and electing not to store all renditions associated with the one or more available rendition upgrades that fail to meet a minimum rendition upgrade threshold.

In some aspects, the techniques described herein relate to a system for performing storage decisions for a content cache, including: a content cache including a memory store for storage of media content objects; and a storage manager in operative communication with the content cache and operative to: identify one or more renditions for one or more media elements of one or more media objects; determine a storage utility for the one or more renditions; calculate a rendition upgrade value for available rendition upgrades, wherein the rendition upgrade value is based on an incremental storage utility of a rendition upgrade and an incremental storage size of the rendition upgrade; sort a listing of one or more available rendition upgrades by the rendition upgrade value; and elect not to store all renditions associated with the one or more available rendition upgrades that fail to meet a minimum rendition upgrade threshold.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system architecture in which a service provider is an integrated service of a communication provider.

FIG. 2 illustrates an example system architecture in which a service provider is a stand-alone service for the delivery of media object selection with rendition selection.

FIG. 3 illustrates an example of a media delivery system.

FIG. 4 illustrates an example of a media delivery system in which a shared communications channel comprises a satellite in communication with groups of user systems via spot beams.

FIG. 5 illustrates an example user terminal comprising a user media module.

FIG. 6 illustrates an example provider media module.

FIG. 7 illustrates a schematic example of a media object.

FIG. 8 illustrates an example of a manifest for a video media object.

FIG. 9 illustrates an example of a method for electing renditions of a media element of a media object to store in a content cache.

FIG. 10 illustrates an example of a method for determining a rendition upgrade value for a plurality of renditions of a media element of a media object stored in a content cache.

FIG. 11 illustrates an example of a method for determining storage utility of renditions in a content cache.

FIG. 12 illustrates an example of a matrix of expected delivery actions in relation to possible user behaviors and storage states.

FIG. 13 illustrates an example of a method for determining behavior probability of possible user behaviors.

FIG. 14 illustrates an example of raw historical user behavior data.

FIG. 15 illustrates an example of raw historical user behavior data labeled as training data for model training.

FIG. 16 illustrates an example of training data labeled with feature vectors comprising predictor variables.

FIG. 17 illustrates an example of model input data to determine a behavior probability for a possible user behavior.

FIGS. 18-22 include tables illustrating an example of an application of a storage decision method to renditions in a cache.

FIG. 23 illustrates an example method for determining an expected action for delivery of a media object to a user based on delivery utility.

FIG. 24 illustrates an example method for determining a provisioning cost value of a rendition.

FIG. 25 illustrates an example method for determining a churn cost value of a rendition.

FIG. 26 illustrates example computing devices for executing functionality described herein.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

As noted above, content caches may be provided in a communications system to provide improved performance of the system. For example, media objects may be prepositioned in the content cache of a user system during low network utilization periods, such as off-peak periods. In addition, media objects that have been multicast over a shared forward link in response to a request from another user may be stored at one or more non-requesting user content caches. In either example, it may be efficient to provide such prepositioned content to the user cache. In the case of prepositioning during low network utilization periods, there may be excess available bandwidth of a network that may be utilized to provide prepositioned content. In the case of a multicast communication, it may be appreciated that the “cost” (e.g., use of network resources) to deliver content to a plurality of user systems that can receive data over a shared forward link may be similar or even the same whether delivered to a single (e.g., requesting) user system or a plurality of user systems (e.g., including a requesting user system and one or more non-requesting user systems). In any regard, a media object that may be requested by the user system may be available at the content cache local to the user system such that a media object may be delivered in response to a request from the local cache.

In turn, a content cache with prepositioned media objects at a user system may provide benefits in a communication system by allowing such prepositioned data to be opportunistically delivered to the user cache in an efficient use of network resources. Some requests from the user system may be served using media object data from the user cache. This may alleviate strain on a communication network by avoiding network resource use that may occur at an inopportune time (e.g., during a peak period in which available communication network resources may be limited). Further still, variables associated with the delivery of content over the network communication system (also referred to as “over-the-air” herein) may, at least in some instances, create a lesser quality of experience for a user. Delivery of prepositioned content from a local cache may provide a more consistent and, potentially, higher quality of experience for a user.

However, these benefits attendant to a content cache may be heightened if the content stored in the content cache is of value to the user system at which the content is stored. For example, if a user is unlikely to request a media object stored in the local content cache, the stored media object may have little value but still occupies storage resources. As may be appreciated, the storage resources of a content cache are finite and limited. In turn, determining what content to store or keep in a content cache can greatly affect the benefits provided by a content cache. Moreover, media objects may comprise one or more media elements, and the media elements may be offered as different renditions requiring different levels of resource (e.g., network and/or storage) utilization. As such, the value of different renditions of one or more media elements may be determined and utilized in making storage decisions at a user cache.

In view of the foregoing, the present disclosure provides examples of techniques that may be used to make determinations regarding storage decisions for media object content at a content cache that may optimize the value of content in the content cache. With the increased value of cached media object content in a user content cache, the communication system may experience overall improved efficiencies. For instance, a larger proportion of requested content may be stored locally at user content caches in the communication system such that less bandwidth may be required during resource-constrained times, such as peak usage periods. Furthermore, the benefit of prepositioned content delivered in times when excess network resources are available may be increased, further reducing potential bandwidth consumption in the communication network while still fulfilling user requests. As such, the overall quality of experience for users of the system may be increased without providing additional network resources or upgrades. This may allow for more users to be served using existing network resources or may allow for improved quality of experience for existing users without requiring network upgrades. The present disclosure may provide enhanced technical benefits to communication system hardware such that the communication system may be improved.

In general, the techniques of the present disclosure may be used to make storage decisions regarding media object content in a content cache. The storage decisions may relate to what content to evict from a content cache or may relate to whether to store received content (e.g., in lieu of or in addition to existing stored content). The storage decisions may be made in relation to rendition upgrades. Rendition upgrades may represent available upgrades from a lower quality rendition of a media element of a media object to a higher quality rendition. The present disclosure may utilize a rendition upgrade value that represents an incremental storage utility of a rendition upgrade and an incremental storage size of a rendition upgrade. As will be discussed in greater detail below, this approach utilizing rendition upgrade values may provide benefits from using absolute storage utility values.

For example, when performing storage decisions according to the present disclosure, determinations may be made regarding which renditions of one or more media elements of a media object would be most valuable to maintain in the content cache, understanding that there may be only negligible value in storing multiple different renditions of the same media object on the same content cache. Furthermore, the use of rendition upgrade values may allow for the relative value of rendition upgrades for a media object to be considered in relation to the relative value of rendition upgrades of other media content objects. In turn, the value of content stored in the content cache may be improved, enhancing the benefits of content cache use noted above.

In some examples provided herein, a machine learning model may be trained and utilized to predict the probability of possible user behaviors. In addition, the present disclosure presents ways to understand and determine the value of reacting to certain user behaviors in certain ways through the use of a delivery utility. As described herein, the determination of a delivery utility for media object data may be used to determine an expected delivery action for a media object. For example, an expected delivery action may be determined for a plurality of model scenarios in which storage states of the content cache and playback device details vary. That is, a determination of what rendition would be served for respective ones of the plurality of model scenarios may be based on the delivery utility of available renditions in each of the plurality of the model scenarios. The net expected delivery utility of having one storage state relative to another storage state may be determined by utilizing the probability of user behaviors, expected delivery actions related to the possible user behaviors (e.g., as a function of storage state), and the delivery utility of the media object renditions that would be served in the expected delivery actions. This net expected delivery utility of storing one rendition relative to another may be referred to as the storage utility of a rendition of the media object and can form a basis of media object storage decisions.

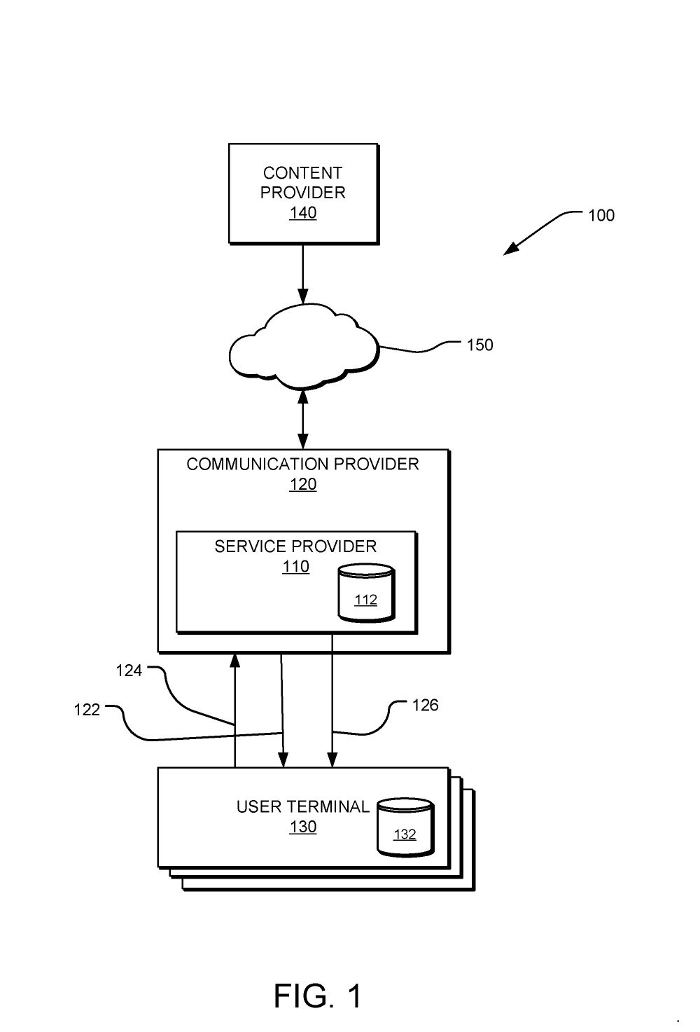

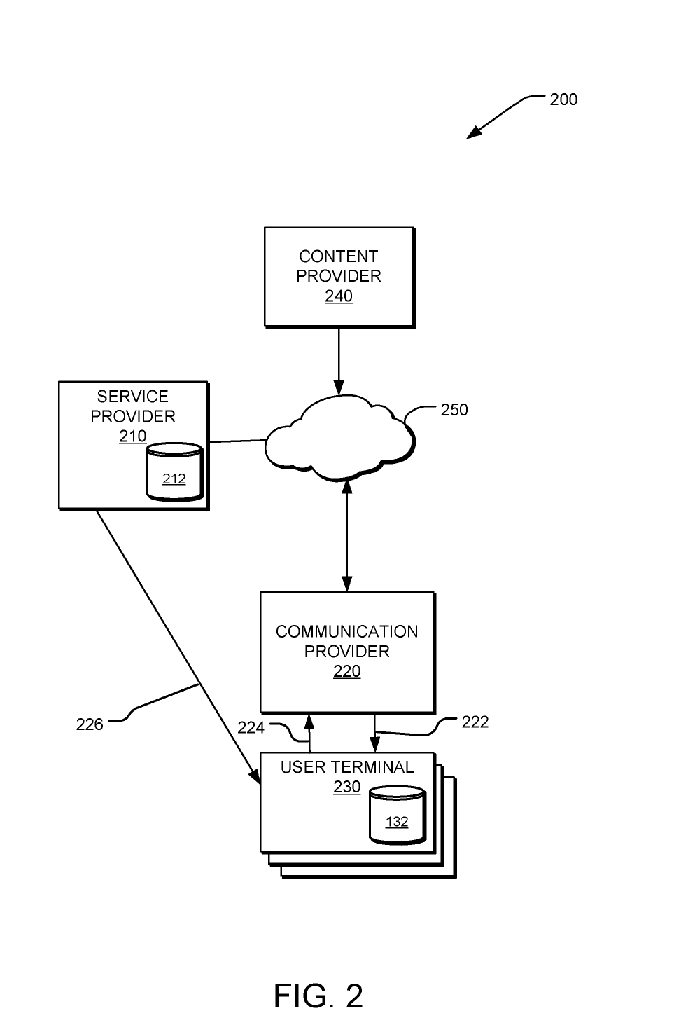

FIG. 1 illustrates an example of a network environment 100 that provides one context for the present disclosure. The example network environment 100 shown in FIG. 1 may be referred to as a unitary system because a service provider 110 and a communication provider 120 comprise a common entity. In contrast, a stand-alone service provider is discussed in FIG. 2 below, in which the service provider and the communication provider may be separate entities.

The network environment 100 may include one or more content providers 140. A content provider 140 may be a source of content. For example, the content provider 140 may be a content owner such as a studio or other content creator. In other examples, the content provider 140 may be a licensee, distributor of content, content aggregator, or other source of content. As such, the content provider 140 may comprise one or more content distribution networks that are operated by, or under license from, a content owner. In one example, a content provider 140 may be a streaming service that hosts a media catalogue of media objects.

The communication provider 120 provides data communication services to a plurality of user terminals 130. The communication provider 120 may alternatively be referred to as an Internet Service Provider (ISP). The communication provider 120 may provide communication services to a plurality of user terminals 130 using any one or more networking infrastructures. For example, the communication provider 120 may be a telecommunications provider that may provide data communications to user terminals 130 by way of a publicly switched telephone network (PSTN), digital subscriber line (DSL), television cable (CATV), integrated services digital network (ISDN), fiber optics, satellite communications, cellular communications, or other networking infrastructure. The communication provider 120 may provide data communication services that allow a user terminal 130 to access a wide area network, such as the Internet. In this regard, the communication provider 120 may provide communication services other than providing media content objects, such as email communications, websites, peer-to-peer communications, or other services.

As such, the network infrastructure of the communication provider 120 may facilitate unicast communication exchanges between a user terminal 130 and a destination over a wide area network 150, such as by way of packet-switched networking protocols such as the internet protocol suite (TCP/IP) or other appropriate protocol. In this regard, as shown in FIG. 1, the communication provider 120 may provide a forward link 122 and a return link 124 that allows for bidirectional communication of a user terminal 130 with a wide area network. The forward link 122 and return link 124 may include unicast communications that facilitate wide area network access (e.g., Internet access) to the user terminal 130.

In the unitary example shown in FIG. 1, the communication provider 120 may also include a service provider 110. A shared forward link 126 may be established between the service provider 110 and the user terminal 130. In the example shown in FIG. 1, the shared forward link 126 may be a separate communication link or may share resources with the forward link 122 as the service provider 110 may be integrated with the communication provider 120. In any regard, the shared forward link 126 of the service provider 110 may provide a multicasting capability to provide a requested media object to a plurality of user terminals 130 using the shared forward link 126. By leveraging the potential efficiencies of a shared forward communication link, the service provider 110 may improve the utilization of networking hardware infrastructure, for example, by prepositioning content to a plurality of user terminals 130 and/or by opportunistically delivering multicast content to non-requesting user terminals 130 using the same level of required network resources to deliver the content to fulfill a request from a requesting user terminal 130. The shared forward link 126 may be dedicated to providing media content objects to user terminals 130 in the network environment 100 or may provide multiple types of data to the user terminals 130.

The communication provider 120 may comprise an edge node of a broader network of the communication provider 120. In this regard, the communication provider 120 may include a provider content store 112 that may cache media objects at the edge node of the communication provider 120 to help efficiently communicate media objects to a user terminal 130.

In the unitary example of FIG. 1, the communication provider 120 may have the capability to provide a multicast communication to a plurality of user terminals 130 using the shared forward link 126. As such, the multicasting capability of the communication provider 120 may be utilized by the service provider 110 to provide a rendition of a media element of a requested media object to the plurality of user terminals 130. However, the communication provider 120 may also provide unicast communications with the user terminal 130, as described above. In this regard, in some network architectures (e.g., satellite communication networks), the forward link 122, return link 124, and shared forward link 126 may all be provided by the same networking infrastructure. That is, the networking infrastructure may include hardware that facilitates both the forward link 122 and shared forward link 126 using the same network components. For example, in a satellite communication system, a satellite may establish spot beams and/or carriers that may facilitate unicast communication of the user terminal 130 and multicast communications between the service provider 110 and the user terminal 130.

The user terminal 130 may comprise hardware, software, and firmware located at a user’s premise. The user terminal 130 may include communication equipment to facilitate communication with the communication provider 120 and to receive a multicast from the service provider 110. In this regard, the user terminal 130 may include networking equipment that allows communication of unicast data between the user terminal 130 and the communication provider 120, as well as receipt of multicast communications from the service provider 110. In the context of the unitary system of FIG. 1, some communication links utilized by the communication provider 120 and the service provider 110 may be the same (e.g., in the case of a shared forward link provided by a common service provider 110/communication provider 120).

As described in greater detail below, the user terminal 130 may comprise a playback device that allows a user to view a media object delivered by the service provider 110. The user terminal 130 may provide functionality to allow a user to browse and request media content using hardware at the user terminal 130 (e.g., including a playback device that provides a user interface to a user). The user terminal 130 may include a user agent that executes an application, such as a content provider application, an internet browser, or another application, that allows a user to browse a media catalogue and request a media object for viewing. As may be appreciated, such browsing may be facilitated by unicast communication flows between the user terminal 130 and a remote entity via the forward link 122 and the return link 124 (e.g., through the exchange of hypertext transfer protocol (HTTP) messages).

Furthermore, the user terminal 130 may include a content cache comprising a user cache 132. The user cache 132 comprises local storage resources in which media objects may be stored locally at the user terminal 130.

In the network environment 100, the user terminal 130 may communicate with the communication provider 120 and service provider 110 to facilitate the delivery of a requested media object to the user terminal 130. For example, the user terminal 130 may communicate via unicast communications with the communication provider 120 to access and browse a media catalogue of the content provider 140. The media catalogue of the content provider 140 may comprise an internet resource that is accessed by the user terminal 130 using the network of the communication provider 120. Accordingly, the user terminal 130 may be able to access a plurality of content providers 140 such that the illustration of a single content provider 140 in FIG. 1 is intended to be illustrative and not limiting.

The user terminal 130 may present an interface to a user that allows a user to navigate the media catalogue of the content provider 140. Upon selection of a media object by the user terminal 130, the service provider 110 of the communication provider 120 may intercept the request for the media object. At this point, the service provider 110 may determine a rendition of a requested media object to serve to the user terminal 130 in a manner that enhances the efficiency of the network. This may include delivery of a rendition of the media object from the user cache 132 in response to a request. As such, optimizing the value of content in the user cache 132 may improve the efficiency of the network environment 100, as described above.

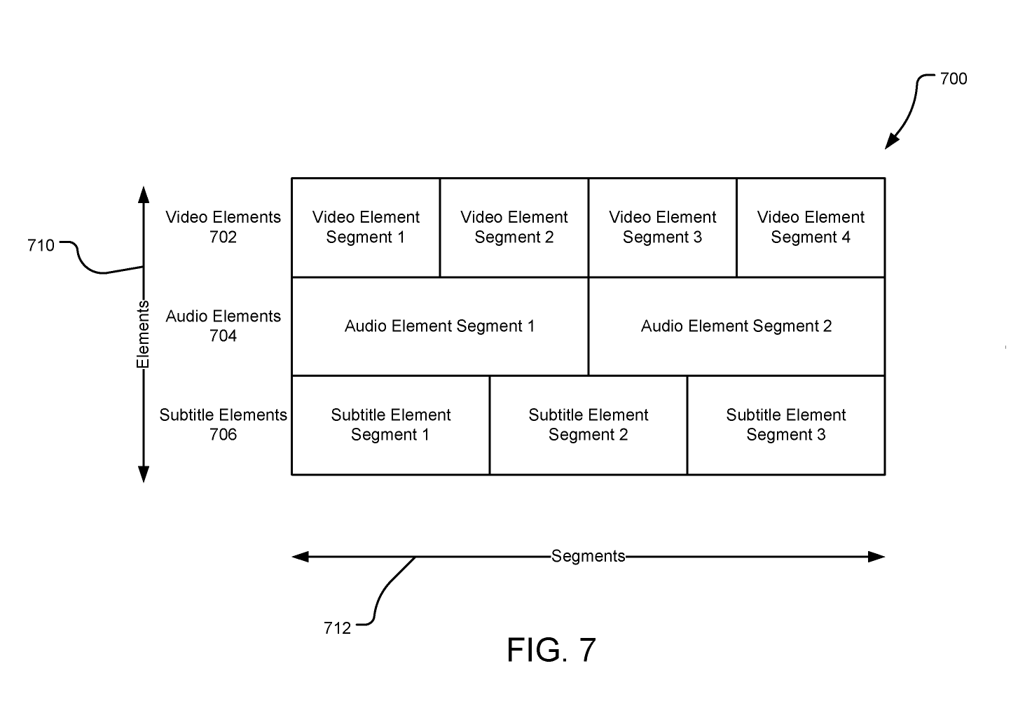

As used herein, a rendition may refer to a specific instance of a media element of a media object. With further reference to FIG. 7, a schematic illustration providing details on the makeup of a media object is presented. Specifically, a media object 700 may comprise a plurality of media elements, each of which may have various renditions available. A media object may be part of a media catalogue provided by a content provider. A media object may comprise a movie, an episode of a television series, a song, a podcast, etc.

The media object 700 may comprise a plurality of concurrent media elements 710 that may collectively define the media object 700 to be rendered at the user system. While a media object 700 is referenced herein that denotes a plurality of media elements 710 that are concurrently rendered to provide the media content, the present disclosure is equally applicable to any media object, including those having a single media element, such as an audio media object.

In one example, the media object 700 may include media elements 710 comprising a video element 702, an audio element 704, and a subtitle element 706. Additional or fewer media elements may be provided for various media objects. As noted above, in some examples, a media object may comprise a single media element (e.g., an audio element for an audio media object). The media elements 710 may comprise components or layers of the media object 700 that may be concurrently rendered to provide the media object 700 to a user for consumption. For example, the media object 700 may include a video element 702, which is accompanied by an audio element 704 comprising an audio track concurrent to the video element 702. While specific examples are described herein for illustration, media elements 710 of the media object 700 may include any appropriate media elements such as video elements, audio elements, subtitle elements, metadata elements, or other media elements.

In addition to the media elements 710, additional data comprising an extra may be provided in connection with the media object 700. Such extras may include metadata or other information presented with the media object 700. In an example, an extra may be an advertisement or the like. In this regard, the extra comprising an advertisement may correspond in some way to the media object 700 or may correspond to the user system requesting the media object 700. For instance, the extra may comprise a targeted advertisement based on the media object 700 or the user system requesting the media object 700.

Each element of the media object 700 may be divided into segments 712, with a segment corresponding to a defined portion (e.g., a full or partial duration) of the media object 700. As shown in FIG. 7, each of the video element 702, the audio element 704, and the subtitle element 706 may comprise a plurality of segments 712 of a given duration of the media object 700. In this regard, the horizontal axis of FIG. 7 may be representative of time. A given duration (e.g., 60 seconds) of a media object 700 may be divided (or the media elements 710 comprising the media object 700 may be divided) into segments 712 (e.g., 1-second segments, 3-second segments, 5-second segments, etc.).

The segment lengths of each media element may be unique for at least some of the media elements 710. For example, in FIG. 7, the video element segments may be of a different duration than the audio element segments and may be of a different duration than the subtitle element segments. That is, segment durations need not be the same for each of the media elements 710 comprising a media object 700 such that, for example, a video element 702 may comprise a video segment duration (e.g., 1 second) whereas an audio element 704 may comprise an audio segment duration (e.g., 3 seconds) that is different than the video segment duration. In other examples, the media element segments for different media elements 710 may be of the same duration (e.g., a video element segment and an audio element segment may be of the same duration). It is also possible for the segments of an element (e.g., a video element) to be of different durations. In any regard, media elements 710 of the media object 700 may be rendered together to present the media object. In addition, data for media element segments may be sequentially requested from a manifest for each of the media elements comprising the media object 700 to render the media object 700 at a user system (e.g., through HTTP messages or other protocols).

The delivery of the media elements 710 of a media object 700 may be coordinated using a manifest. A manifest may identify resources for use at a user system such that the user system may request and receive data for the media elements 710 to render the media object 700. In an example, a media player executed by hardware and/or software of the user system may be operative to read the manifest to request data identified in the manifest for rendering by the media player at the user system. A manifest may identify a plurality of renditions of one or more media elements that are available to be requested for the media object. Each rendition identified in the manifest may include one or more attributes that are readable by the client system. In addition, the manifest may include pointer information for each rendition that identifies resources for requesting the rendition of the media element of the media object. Accordingly, the manifest may identify the renditions having different attributes for the media elements that are available for request by a user system to render the media object, along with a pointer that can be used for requesting the rendition. A manifest can identify both media data and metadata. The manifest typically identifies different renditions of each media element that may have unique qualities or characteristics for the media element.

A manifest (e.g., received from a media content provider, content delivery network, or another source) may initially identify a large number of renditions for different ones of the media elements of the media object. Different renditions of the media elements may comprise different network usage characteristics or other qualities. Alternatively, the different renditions of the media elements may relate to other characteristics such as geolocation (e.g., to provide appropriate audio language renditions and/or subtitle language renditions for a given media object). Further still, the different renditions may relate to different capabilities of the user devices rendering the media object. For instance, renditions may be provided that comprise different codecs used to encode and decode media data of the media element. In this regard, the manifest may provide a user system with a "menu" of available renditions of media elements that may be requested. A variant of the media object may comprise a selection of renditions for each media element of the media object. As such, different variants of the media object may differ with respect to at least one rendition of a media element of the media object. As may be appreciated, different renditions of a media content object may have different values for delivery and storage in a media delivery system.

As described herein, determinations may be made regarding determining storage utility and/or delivery utility for a rendition of a media element of a media object. The descriptions provided herein are not intended to limit the approaches described herein to the evaluation of renditions of a single media element of a media object. For example, while a discussion of video renditions may be described herein, it may be appreciated that the same approaches may be applied to other media elements of a media object, such making determinations for storage of different renditions of audio elements, subtitle elements, etc. Moreover, the approaches described herein may be applied to renditions of more than one media element of a given media object.

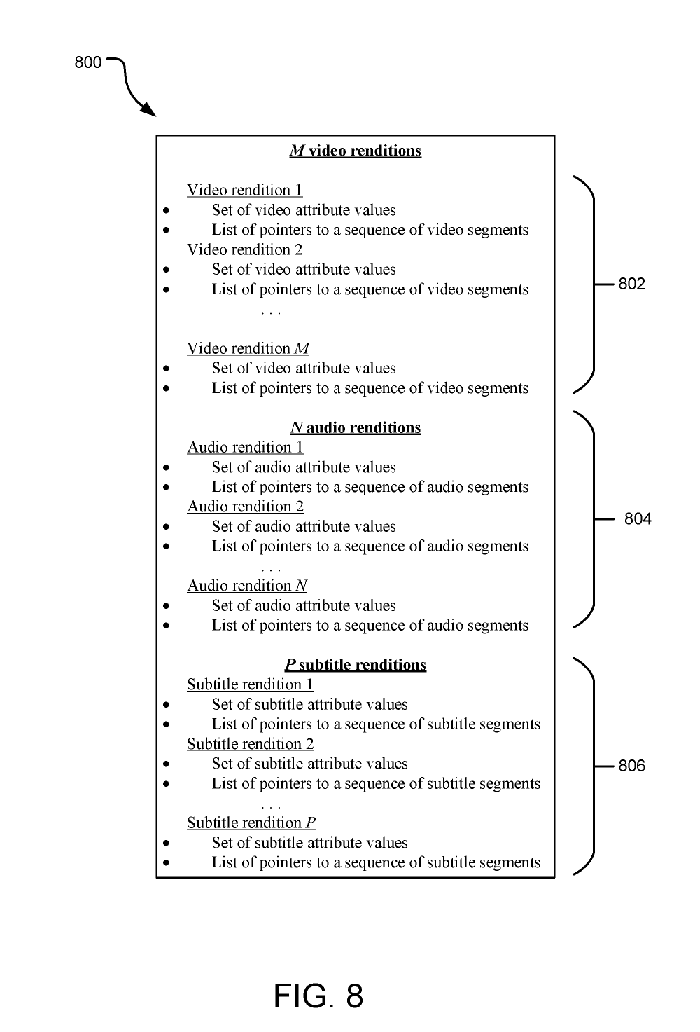

With additional reference to FIG. 8, an example of a manifest 800 is illustrated. The manifest 800 is an example of a video media object comprising three concurrent media elements: a video element 802, an audio element 804, and a subtitle element 806. As shown, the manifest 800 can identify multiple renditions for each media element. Each rendition may correspond to a unique version of a media element. As such, each rendition may include a set of one or more attributes that describe the rendition. The one or more attributes may be readable by a provider-media module or a user system. The attributes may define characteristics of the specific rendition of the media element. Each rendition of a media element may also include a list of pointers (e.g., universal resource locators (URLs), universal resource indicators (URIs), or the like) that may be utilized by a user system to request a sequence of segments of the rendition.

In other examples, a manifest may be hierarchical with a top-level manifest including a listing of lower-level manifests. As an example, a top-level manifest may include a video manifest and an audio manifest. Each of the video manifest and the audio manifest may include renditions for video media elements and audio media elements, respectively. In turn, each lower-level manifest may include a listing of renditions that each include a list of pointers for use by a user system in requesting a sequence of segments of the renditions.

In the example illustrated in FIG. 8, the media object comprises M number of renditions of the video element 802, N number of renditions of the audio element 804, and P number of renditions of the subtitle element 806. In this regard, M, N, and P may each be independent variables of one or more renditions of each respective media element.

With regard to the video element, each video rendition is defined by a set of video attributes and comprises a list of pointers to sequential video segments that, when played, render that rendition of the video element of the media object. Examples of video attributes that can define a video rendition include an encryption format, a video encoding format (video codec), a quality level (e.g., a color model, a resolution, etc.), a dynamic range, and the like. Other examples of video attributes that define video renditions may include a %-seg value, maximum bit rate, average bit rate, a required bandwidth value (e.g., a network bandwidth measure required to deliver the rendition), a required latency value (e.g., a network latency measure required to deliver the rendition), and supported media player operating system(s). Here a %-seg value can correspond to the frequency at which the rendition has been consumed by a user. In some examples, the %-seg value of each rendition of a concurrent media element in a manifest can correspond to the frequency of user use relative to the other renditions of the concurrent media element. Thus, for example, the %-seg values of each video rendition in a manifest sum to 100%. As may be appreciated, different renditions may have different combinations of attributes, including combinations of any of the foregoing (e.g., a given resolution, encryption, a color model, and an average bit rate).

As noted above, some examples provided herein specifically refer to video renditions of a video element of a media object. However, the use of specific types of renditions (e.g., video renditions, audio renditions, etc.) is for illustration and is not considered to be limiting. That is, the approaches described herein may be generally applicable for the evaluation of any set of renditions of any media element of a media object. In this regard, video renditions of a video element are used for illustration as renditions of video elements tend to be of larger size than audio renditions or other media element renditions. Thus, the use of the present approaches for the evaluation of video renditions of a video element may provide the greatest impact on network efficiency. Further still, certain examples presented herein illustrate the approaches described herein relative to video renditions having different respective values for a given attribute (e.g., bitrate). That is, certain examples herein refer to renditions having the same attributes other than bitrate as having a common format for a given title of a media object. Thus, renditions that vary with respect to their bit rates but that otherwise have a common format (e.g., common attributes other than bit rates) are discussed. However, the teachings presented herein are not limited to this context. Rather, renditions varying with one or more different attributes may be evaluated using the approaches herein.

As also shown, each audio rendition is defined by a set of audio attributes and comprises a list of pointers to sequential audio segments that, when played, render that rendition of the audio element of the media object. Examples of audio attributes that can define an audio rendition include audio encoding format (audio codec), a number of audio channels, audio language, a required bandwidth value, a required latency value, and quality level. Other examples of audio attributes include a %-seg value (as described above), bit rate, and supported media player operating system(s).

Still referring to the example illustrated in FIG. 8, each subtitle rendition is defined by a set of subtitle attributes and comprises a list of pointers to sequential subtitle segments that, when played, render that rendition of the subtitle element of the media object. An example of an attribute that can define a rendition of the subtitle element includes language (e.g., English, Spanish, French, etc.).

A unique combination of renditions of the media elements of a media object may be referred to as a variant of the media object. In some examples, the approaches described herein may be used to determine storage utilities and/or delivery utilities of a plurality of variants that include different renditions of one or more different media elements. The evaluated variants may include different renditions in a plurality of formats of the media object. That is, by application of the approaches herein to renditions of all media elements of a media object, variants of the media object may, in turn, be stored based on the evaluation of the individual renditions that comprise the variant of the media object to be stored at a user cache.

As may be appreciated, different renditions of a media element of a media object may have different combinations of rendition attributes, including combinations of any of the foregoing (e.g., a given resolution, an encryption, a color model, and an average bit rate). Some renditions of a given media element may share at least one attribute. For example, a first rendition and a second rendition may each have a video resolution attribute of 720p. For example, the first rendition may have a high dynamic range and the second rendition may have a standard dynamic range. In other examples, the first rendition may have a first bitrate and the second rendition may have a second bit rate.

Returning to FIGS. 1 and 2, in contrast to the example of a unitary system of the network environment 100 in FIG. 1, FIG. 2 illustrates a network environment 200 in which a stand-alone service provider 210 may provide a media object to a user terminal 230. Like in the network environment 100, the network environment 200 may include one or more content providers 240 that host media catalogues from which a user of a user terminal 230 may request a media object. The details of the communication provider 120 described above are equally applicable to the communication provider 220 of FIG. 2. That is, the communication provider 220 may be any communication provider that provides a user terminal 230 access to a wide area network 250 using a forward link 222 and a return link 224. The forward link 222 and return link 224 may be provided by the network infrastructure of the communication provider 220 to facilitate general internet access at the user terminal 230.

However, unlike in the network environment 100, the communication provider 220 and the service provider 210 may not be a common entity. Rather, the stand-alone service provider 210 may be a separate entity from the communication provider 220. For example, the stand-alone service provider 210 and the communication provider 220 may be distinct entities that are not co-located but may be in operative communication via a wide area network 250. In this regard, the stand-alone service provider 210 may be in operative communication with the wide area network 250 as well as providing a shared forward link 226 to the user terminal 230 in the network environment 200. As may be appreciated, the shared forward link 226 may be provided to the user terminal 230 using a different networking infrastructure than the forward link 222 and return link 224 provided by the communication provider 220. For example, the stand-alone service provider 210 may operate an independent networking infrastructure to provide the shared forward link 226. The stand-alone service provider 210 may include a provider content store 212 comprising edge node storage of renditions of media objects.

The user terminal 230 may generally be as described above for the user terminal 130. However, the user terminal 130 may include networking equipment for unicast communications with the communication provider 220 while including at least reception equipment for receipt of a multicast communication by the stand-alone service provider 210 over the shared forward link 226.

Accordingly, a service flow in the network environment 200 may differ from the network environment 100. Initially, like in the network environment 100, the user terminal 230 may utilize unicast communications over the forward link 222 and return link 224 of the networking infrastructure of the communication provider 220 to access and browse a media catalogue of the content provider 240. Moreover, a user of the user terminal 130 may initiate a request for a media object from the media catalogue of the content provider 240.

In the network environment 200 of FIG. 2, the request for the media object by the user terminal 130 may be redirected to the communication provider 220 for processing the request to serve the requested media object to the user terminal 230. That is, a content provider 240 may redirect the user terminal 230 to the stand-alone service provider 210 such that the stand-alone service provider 210 receives the request via the wide area network 250.

In this regard, the stand-alone service provider 210, having received the redirected request for the media object, may coordinate serving a rendition, which may include delivery of a locally cached rendition stored in the user cache 132. As noted above, the transmission of a rendition over the shared forward link 226 may result in other user terminals 230 on the shared forward link 226 also receiving the rendition. In this regard, like in the network environment 100, determinations for the user cache 132 of what renditions to store may be made according to the approaches described herein.

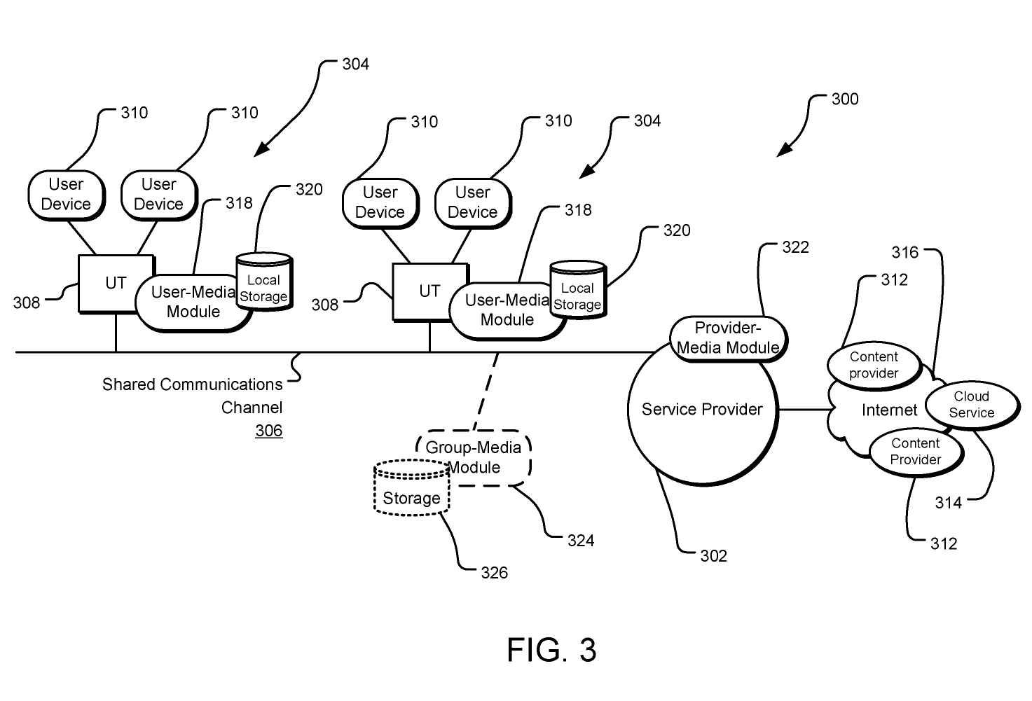

Turning to FIG. 3, an example of a media delivery system 300 is shown where the approaches described herein may be utilized. A service provider 302 (e.g., which may be unitary with a communication provider as described in FIG. 1 or a stand-alone service provider as described in FIG. 2) provides connectivity to one or more user systems 304 on a shared forward communication link comprising a shared communications channel 306. While specific implementations of the shared communications channel 306 are illustrated below, the shared communications channel 306 may comprise a shared forward link of a cable television network, a satellite communication network, a cellular network, or any other network infrastructure. The service provider 302 may be operative to multicast content to the user system 304 using the shared communications channel 306.

Each user system 304 can comprise a user terminal 308 (UT) capable of receiving data from the service provider 302 via the shared communications channel 306. The service provider 302 can provide media objects to user devices 310 from one or more content providers 312 (e.g., via a content delivery network of the content providers 312), one or more cloud services 314, or other sources of media objects via the Internet 316 or another wide area communications network. Examples of user devices 310 at a user terminal 308 include but are not limited to, a smartphone, a connected television set, a laptop or desktop computer, tablet computers, a set-top box, or any other user premise equipment device capable of rendering media objects. Each user system 304 may also include a user-media module 318 and local storage 320 (e.g., comprising a local content cache) capable of caching media objects, variants of media objects, or renditions of media elements of a media object. The user-media module 318 may receive a redirected or intercepted request in response to a user requesting a media object. In turn, the user-media module 318 may coordinate with a provider-media module 322 to complete a request for a media object at the user terminal 308. The user-media module 318 may manage cached media objects from the local storage 320, including coordinating an index (e.g., a dictionary) for the local storage 320 with the provider-media module 322. Additionally, the user-media module 318 may communicate data regarding media consumption, playback device parameters, or other parameters regarding the user system 304. In addition, the user-media module 318 may include a storage manager that may make storage determinations regarding content stored (or to be stored) in the local storage 320.

The user-media module 318 may comprise appropriate hardware, software, and/or firmware to execute this functionality. For example, the user-media module 318 may comprise an application-specific integrated circuit (ASIC), a field programmable gate array (FPGA), a hardware processor in operative communication with a memory, or other devices. In the case of a processor and memory, the memory may store machine-readable instructions that configure the processor to perform the functionality described for the user-media module 318.

In some examples, there may be a group-media module 324 connected to the shared communications channel 306, which may include user-group storage 326 (e.g., comprising a content cache) for a group of one or more of the user systems 304 connected to the service provider 302 via the shared communications channel 306. The group-media module 324 may coordinate a request for a media object for delivery to a plurality of user systems 304 (e.g., including user systems of a given multicast domain of the shared communications channel 306). In addition, the group-media module 324 may provide the functionality discussed above for the user-media module 318 relative to a plurality of user terminals 308 of the shared communications channel 306. Further still, the group-media module 324 may include a storage manager for making storage decisions relative to the user-group storage 326 using the approaches described herein.

The group-media module 324 may comprise appropriate hardware, software, and/or firmware to execute this functionality. For example, the group-media module 324 may comprise an application-specific integrated circuit (ASIC), a field programmable gate array (FPGA), a hardware processor in operative communication with a memory, or other devices. In the case of a processor and memory, the memory may store machine-readable instructions that configure the processor to perform the functionality described for the group-media module 324.

As shown, the provider-media module 322 may be located at a provider-side of the shared communications channel 306 (e.g., at or near the service provider 302). The provider-media module 322 may be operated by a communication service provider or by a stand-alone service provider as described above in relation to FIGS. 1 or 2, respectively. The provider-media module 322 may be executed at a server of the service provider. The provider-media module 322 may be operative to determine delivery utility for one or more renditions of a media object as described in greater detail below. Furthermore, the provider-media module 322 may coordinate the multicasting of a rendition of a media object in response to a request. In addition, the provider-media module 322 may maintain storage indexes that correspond to the local storage 320 of the user terminals 308. In this regard, storage decisions for one or more local storages 320 may be made at the provider-media module 322. In other examples, portions of the approaches described herein may be performed at the provider-media module 322. Additionally, the provider-media module 322 may coordinate storage and request for media objects from upstream CDNs.

The provider-media module 322 may comprise appropriate hardware, software, and/or firmware to execute this functionality. For example, the provider-media module 322 may comprise an application-specific integrated circuit (ASIC), a field programmable gate array (FPGA), a hardware processor in operative communication with a memory, or other devices. In the case of a processor and memory, the memory may store machine-readable instructions that configure the processor to perform the functionality described for the provider-media module 322.

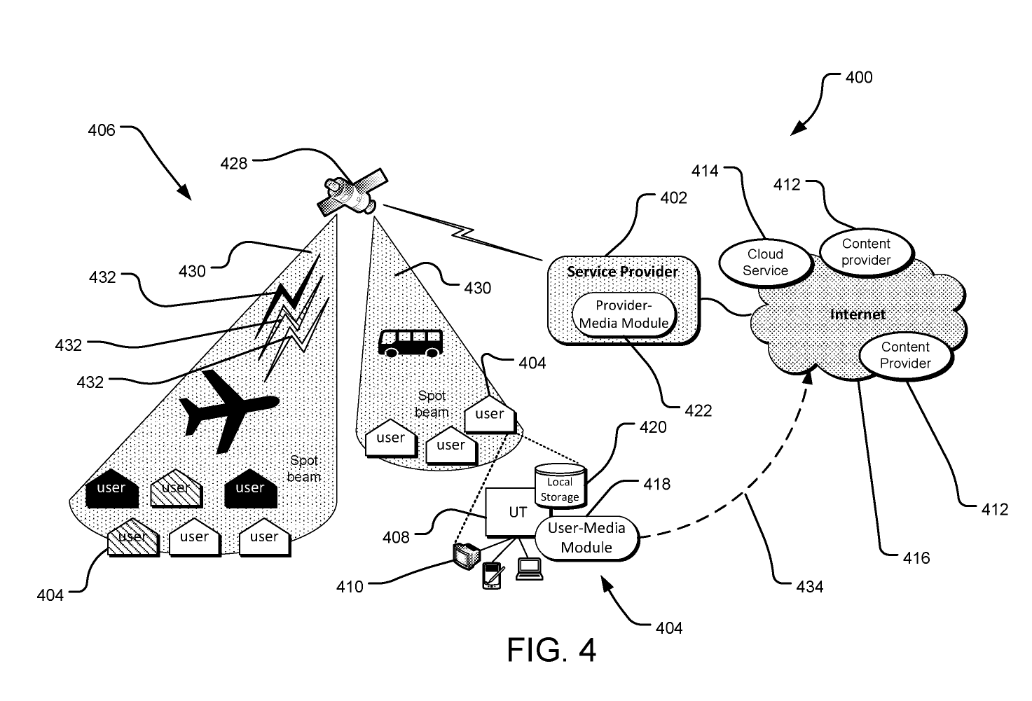

FIG. 4 illustrates a specific example of a media delivery system 400 in which a shared communications channel 406 comprises a satellite 428 in communication with groups of user systems 404 via spot beams 430. In this regard, user systems 404 in a given spot beam 430 may be included in a shared communication channel. Furthermore, in some examples, a spot beam 430 may have multiple carriers 432. In FIG. 4, the multiple carriers 432 are represented with different shadings. The shadings of the user systems 404 reflect the respective one of the multiple carriers 432 to which a user system 404 belongs. Accordingly, a shared communication channel or shared communication link may comprise a given carrier 432 within a spot beam such that user systems 404 tuned to the given carrier 432 in a spot beam 430 may belong to the shared communication channel.

In any regard, FIG. 4 may be a specific implementation of the media delivery system 300 shown in FIG. 3 in which the shared communications channel 306 may include the satellite 428, spot beams 430, and/or carriers 432 to deliver content to the user systems 404. As shown, each user system 404 can include a user terminal 408 comprising a satellite terminal (not shown) and one or more user devices 410, which can be any of the user devices mentioned above. Each user system 404 can also include a user-media module 418 and local storage 420 (e.g., comprising a local cache) capable of caching media objects. The user-media module 418 may also provide similar functionality to the user-media module 318 noted above. In examples of a unitary system, the satellite 428, spot beams 430, and/or carriers 432 may provide networking infrastructure to support both the unicast communications of a forward link and return link as well as a shared forward link.

The media delivery system 400 may also include a provider-media module 422 at a service provider 402 that has similar functionality described above. Also, while not shown, a group-media module and/or group cache like that discussed above may be provided in connection with one or more of the spot beams 430 to provide similar functionality as that described above for the group-media module 324 and user-group storage 326 relative to the shared communications channel 306.

The media delivery system 400 may also include one or more media content providers 412 and/or one or more cloud services 414. The one or more media content providers 412 and/or one or more cloud services 414 may provide media objects to the service provider 402 via a wide area network, such as the internet 416, or another type of communications network.

A user system 404 may utilize the spot beams 430 and carrier 432 of the satellite 428 for unicast communications to provide access to the internet 416. In turn, once a media object is requested, the media object may be delivered to the user system 404 via the spot beams 430 and carrier 432 of the satellite 428. As such, the media delivery system 400 of FIG. 4 may facilitate a unitary system structure as shown in FIG. 1.

Alternatively, a user system 404 may utilize a communication provider link 434 for unicast communication of data via the Internet 416. In this regard, upon selection of a media object, the request may be redirected to the service provider 402 for delivery of the media object to the user system 404 using the spot beams 430 and carrier 432 of the satellite 428 for multicast delivery of the media object. As such, the communication provider link 434 may facilitate a stand-alone service provider architecture as described in FIG. 2.

Further still, FIG. 4 illustrates a number of mobile terminals served by the spot beams 430 and carriers 432 of the satellite 428. As such, the media delivery system 400 of FIG. 4 may provide communication services to mobile terminals as user systems 404. As may be appreciated, the mobile terminals may move between spot beams 430 and/or carriers 432 of the satellite 428. As such, some parameters (e.g., related to provisioning costs, churn costs, historical behavior, behavior probabilities, or other parameters described below) may be different for different spot beams 430 or carriers 432. As such, when a mobile terminal moves to a new carrier 432 or spot beams 430, some aspects related to determining delivery utility for renditions of a media object may be changed in view of the new spot beams 430 and/or carrier 432.

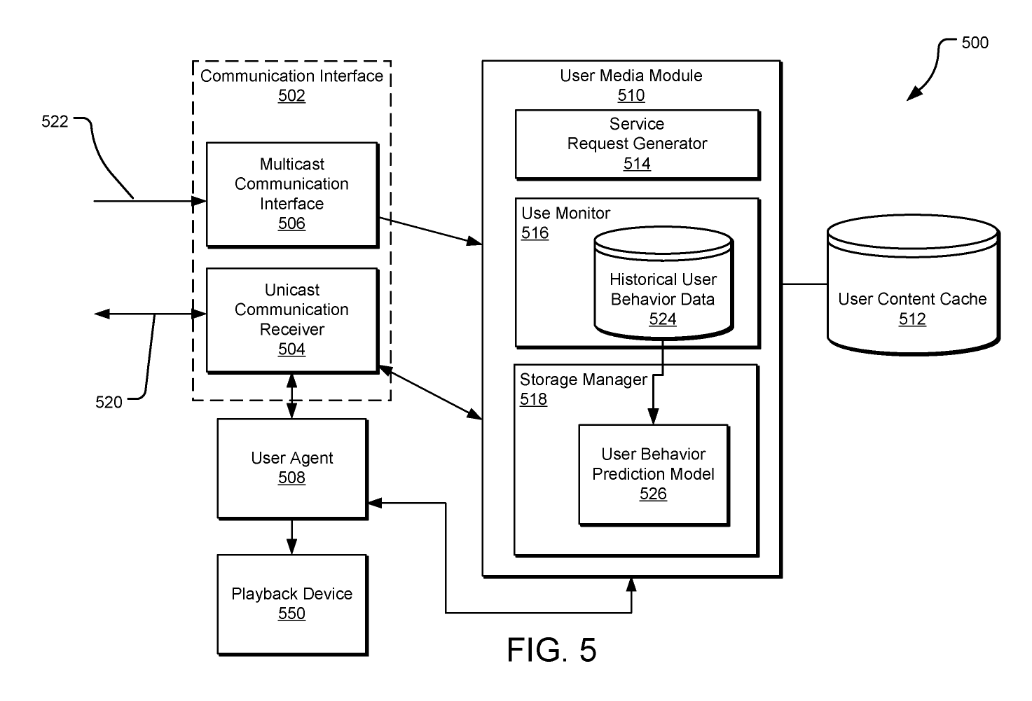

FIG. 5 illustrates a more detailed example of a user terminal 500 that may be utilized in the present disclosure. The user terminal 500 may include a communication interface 502 that facilitates communication with one or more networks to exchange and/or receive data via respective ones of the one or more networks. In this regard, the communication interface 502 may include hardware, software, and firmware that facilitates the exchange of data with one or more networks with which the user terminal 500 is in communication. Specifically, the communication interface 502 may provide bidirectional unicast capability using a unicast communication interface 504 and multicast receipt capability using a multicast communication interface 506.

The unicast communication interface 504 may facilitate bidirectional communication 520 with a wide area network. In one example, the unicast communication interface 504 may receive data via a return link of a communication provider that also provides a shared forward link 522. In this regard, the return link of the bidirectional communication 520 and the shared forward link 522 may be provided via a common network. Alternatively, the unicast communication interface 504 may receive data via a return link that is provided by a separate networking infrastructure from the shared forward link 522. The unicast communication interface 504 may include any hardware, software, and firmware that facilitates the bidirectional communication 520. For instance, the unicast communication interface 504 may include a network interface controller, a wireless network interface controller, a modem, or other components.

The communication interface 502 may also include a multicast communication interface 506. The multicast communication interface 506 may be operative to at least receive a multicast communication via a shared forward link 522 provided by a service provider. The multicast communication interface 506 may include appropriate hardware, software, and firmware to facilitate receipt of the multicast communication. For example, the multicast communication interface 506 may include a receiver, a modem, a network interface controller, or other hardware to facilitate receipt of the multicast communication. As noted above, the shared forward link 522 may be provided over any network infrastructure capable of multicasting data such as, for example, a satellite spot beam, a cellular multicast group, or the like.

The user terminal 500 may also comprise a user agent 508. The user agent 508 may comprise a computing device or module (e.g., a software module) of a computing device that executes functionality for media object selection. For example, the user agent 508 may execute a stand-alone application that provides access to media objects for selection by a given content owner. Alternatively, or additionally, the user agent 508 may execute third-party applications (e.g., of content providers or content owners) to allow a user to browse respective media catalogs available via the third-party applications. Further still, the user agent 508 may execute a web browser that allows a user to browse one or more media catalogues for media object selection. The user agent 508 may be a discrete computing device at the user terminal 500 or may be integrated into a playback device 550.

In any regard, the user agent 508 may execute to allow for user browsing of a media catalogue for the selection of a media object. This may involve bidirectional communications via the unicast communication interface 504. The unicast communication interface 504 may utilize request and response protocols such as (HTTP) to facilitate browsing of the media catalogue. Upon selection of a media object by the user terminal 500, the request from the user agent 508 may be intercepted or redirected to a service provider, as noted above.

The user terminal 500 may also include a playback device 550. The playback device 550 may render a media object for playback to the user. The playback device 550 may include a user interface, including a display screen and audio output that allows a media object to be rendered for consumption by a user. The playback device 550 may comprise peripheral components such as a connected television, projector, audio receiver, or other multimedia component for rendering media to a user. The playback device 550 may be characterized by playback device parameters such as a screen size, a screen resolution, a screen dynamic range, an audio output capability, an audio channel count, playback device hardware parameters, or other information that may affect the ability of the playback device 550 to render a media object.

As noted above, the user agent 508 may be integrated with the media playback device 550, such that the playback device 550 may be a computing device that executes the user agent 508 as well as providing playback functionality for presenting a media content object to a user. Alternatively, as noted above, the playback device 550 may be a peripheral device connected to a device executing the user agent 508. In one example, the user agent 508 may execute on customer premise equipment provided by a communication provider or service provider.

The user terminal 500 may also comprise a user media module 510. As noted above, a user media module 510 may be provided at each user terminal of a shared forward link in a communication system. Moreover, while a user media module 510 is described herein, a group media module may also provide the functionality of the user media module 510 to a plurality of user terminals of a shared forward link. The user media module 510 may be in communication with the communication interface 502 such that the user media module 510 may receive information from a multicast communication interface 506 and may utilize bidirectional communication with the unicast communication interface 504.

The user media module 510 may include a service request generator 514. Upon selection of a media object for playback at the user agent 508, a redirected or intercepted request may be routed to the user media module 510. In response, the service request generator 514 may initiate a request to a provider media module of the service provider to request a selected media object. In an example, upon selection of a media object by the user, the user agent 508 may communicate with the user media module 510. For example, the user agent 508 may redirect a communication to the service request generator 514 or the service request generator 514 may intercept a request for a media object. Alternatively, a communication from a service provider may be received and directed to the service request generator 514. The service request generator 514 may initiate the process of interfacing with a provider media module of a service provider for serving a rendition of the selected media content object. This may include serving a rendition of the media content object from a user content cache 512 local to the user terminal 500.

The user media module 510 may further include a storage manager 518. The storage manager 518 may provide indexing of the user content cache 512 to allow for efficient and rapid referencing of data contained in the user content cache 512. In this regard, the storage manager 518 may provide dictionary coding of the user content cache 512 or other efficient indexing strategies to allow for rapid searching of the user content cache 512 by the user media module 510. In this regard, the storage manager 518 may also share an index such as a dictionary of the user content cache 512 with the provider media module such that the provider media module may also have access to an index of content stored in the user content cache 512.

Furthermore, the storage manager 518 may manage determinations or elections of media object data to retain or evict from the user content cache 512. Operations related to storage decisions that may be performed by the storage manager 518 are described in greater detail below. The user content cache 512 may include prepositioned or other previously stored media object data. However, it may be appreciated that the storage resources of the user content cache 512 are limited. In turn, it is advantageous to optimize the contents of the user content cache 512 with content of value to the user terminal 500. As will be described in greater detail below, the storage manager 518 may coordinate storage and/or eviction decisions based on storage utility determinations of content to be stored in the user content cache 512. This may include analyzing the user content cache 512 to determine stored content to be evicted. Additionally or alternatively, the storage manager 518 may analyze received media object data (e.g., received via the multicast communication interface 506) to determine whether to store the media object data received (and, potentially, make determinations of content to evict to accommodate storage of the received data).

The storage manager 518 may also include a user behavior prediction model 526. The user behavior prediction model 526 may be utilized by the storage manager 518 in connection with determining storage utility for renditions of media objects stored in the user content cache 512. For example, the user behavior prediction model 526 may be used by the storage manager 518 in connection with determining rendition upgrade values based on storage utilities of renditions stored in the user content cache 512.

The user media module 510 may also include a use monitor 516. The use monitor 516 may be operative to monitor media object consumption or other user activity at the user terminal 500. As media objects are requested, cached, or consumed at the user terminal 500, the use monitor 516 may generate information regarding such usage. The use monitor 516 may, therefore, generate and store historical user behavior data in a historical user behavior database 524. The historical user behavior database 524 may include historical user behavior data for the user terminal 500, and/or the historical user behavior database 524 may receive historical user data from other user terminals 500 (e.g., from a provider media module).

In any regard, the historical user behavior database 524 may be utilized to generate training data for the user behavior prediction model 526. The historical user behavior may be locally processed at the user media module 510 by the storage manager 518 to train the user behavior prediction model 526, and/or the use monitor 516 may provide the historical user behavior data to a provider media module for remote model training. In this latter regard, the storage manager 518 may receive information regarding the trained user behavior prediction model 526 from a provider media module. As such, it may be appreciated that the user behavior prediction model 526 may be executed locally at the user terminal 500, remotely (e.g., at a provider media module), or aspects of the user behavior prediction model 526 may be jointly executed at the user terminal 500 and at a remote computing device (e.g., the provider media module).

The use monitor 516 may also monitor quality of experience parameters that may be used to generate historical quality of experience performance for the user terminal 500. As described in greater detail below, the historical quality of experience performance generated by the use monitor 516 may be utilized in determining delivery utility for a rendition.

The user content cache 512 may comprise storage accessible to the user terminal 500. As such, the user content cache 512 may include local computer storage such as a hard disk drive, a solid-state drive, a network-attached storage appliance, or other appropriate local storage hardware located at the user terminal 500.

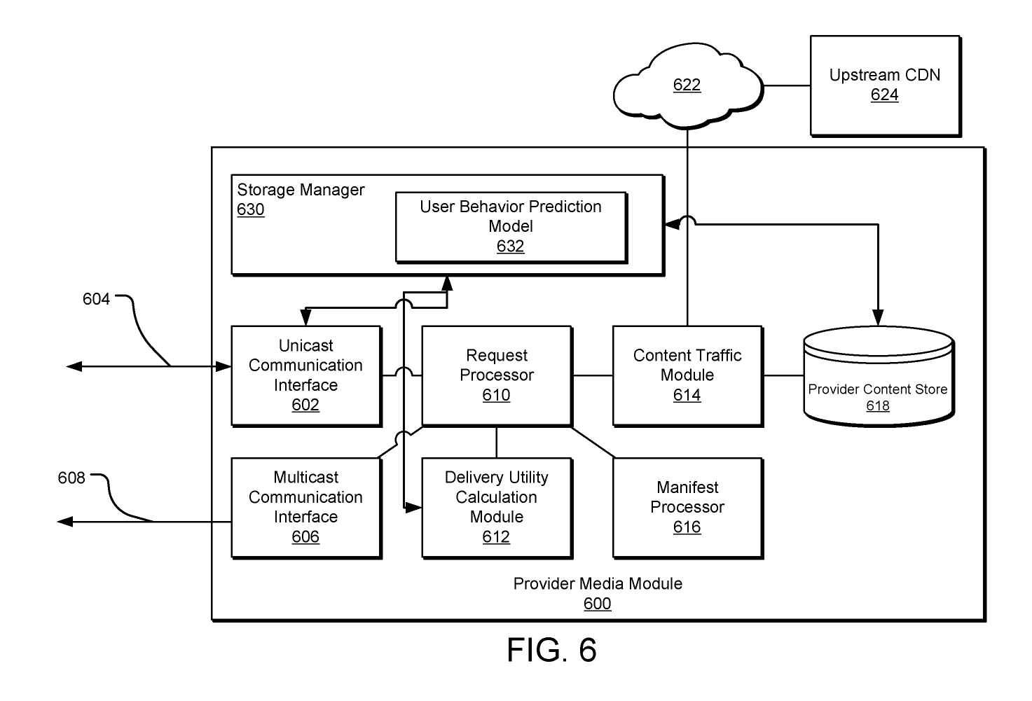

FIG. 6 illustrates an example of a provider media module 600. FIG. 6 includes a more detailed example of a provider media module as described above in relation to FIGS. 3 or 4. In any regard, the provider media module 600 may be located at a service provider or may be executed as a cloud computing instance under the control of the service provider.

The provider media module 600 may include a unicast communication interface 602. In a unitary system in which the communication provider includes the service provider, the unicast communication interface 602 may comprise a return link 604 that may be provided by the same network as a shared forward link 608. Alternatively or additionally (e.g., in the context of a standalone system), the unicast communication interface 602 of the provider media module 600 may include a network interface to a wide area network for receipt of data via a different network as what facilitates the shared forward link 608. In any regard, the unicast communication interface 602 may be operative to receive a request for a media object of a user terminal.

The provider media module 600 may include a multicast communication interface 606. The multicast communication interface 606 may be operative to communicate a media object over a shared forward link 608 to one or more user terminals. As described above, the shared forward link 608 may comprise any communication modality in which multicast communications are provided to user terminals on the client side of the network environment. In this regard, the multicast communication interface 606 may support a satellite network in which the shared forward link 608 may be a satellite spot beam and/or carrier. In other examples, the shared forward link 608 may be a cellular multicast network or other network modality capable of multicasting data to a plurality of user terminals on the client side of the network environment.

The provider media module 600 may include a request processor 610. The request processor 610 may be in operative communication with the unicast communication interface 602 such that a request for the media content object received at the unicast communication interface 602 over the return link 604 may be provided to the request processor 610. The request processor 610 may be in operative communication with a content traffic module 614. The request processor 610 may poll the content traffic module 614 to determine available renditions of the media object. That is, the content traffic module 614 may have access to a provider content store 618 and/or other content distribution networks 624 (e.g., via a wide area network 622) to obtain identifications of the available renditions for the requested media object. Specifically, a manifest of the media object may be provided that may include a plurality of renditions for media elements of the media object. From this information, the content traffic module 614 may determine one or more renditions for at least one media element. For example, the one or more renditions may differ with respect to a bit rate of the media object. In one specific example, the one or more renditions may be video element renditions (or simply video renditions) that may differ with respect to the bit rate of the respective video renditions.

The content traffic module 614 may be in operative communication with a manifest processor 616. The manifest processor 616 may be operative to trim a manifest to remove one or more renditions for a media element for a media object. The manifest processor 616 may perform trimming in multiple stages for a given media object. For example, the manifest processor 616 may perform initial trimming of a manifest to limit the available renditions for a media object prior to calculation of delivery utility for one or more renditions. This may include initial trimming based on, for example, capabilities of the playback device of a user terminal making a request. That is, specific formats of a media content object may be removed from the manifest by the manifest processor 616 prior to determining delivery utility for renditions, as some renditions of a given format may be inappropriate for serving to the user terminal based on the playback device capabilities. For example, manifest trimming may be provided according to Patent Cooperation Treaty Application No. PCT/US2023/022280 filed on May 15, 2023, entitled “MEDIA OBJECT DELIVERY OVER A SHARED COMMUNICATIONS CHANNEL WITH MANIFEST TRIMMING,” the entirety of which is incorporated by reference herein. As such, the manifest processor 616 may provide a trimmed version of an original manifest to the request processor 610 for the determination of delivery utility of a reduced number of renditions as compared to the original manifest. As noted above, in one example, a format of a media object is selected, and all renditions not belonging to the format may be removed. The remaining renditions may correspond to the media object in the format having different respective bitrates.

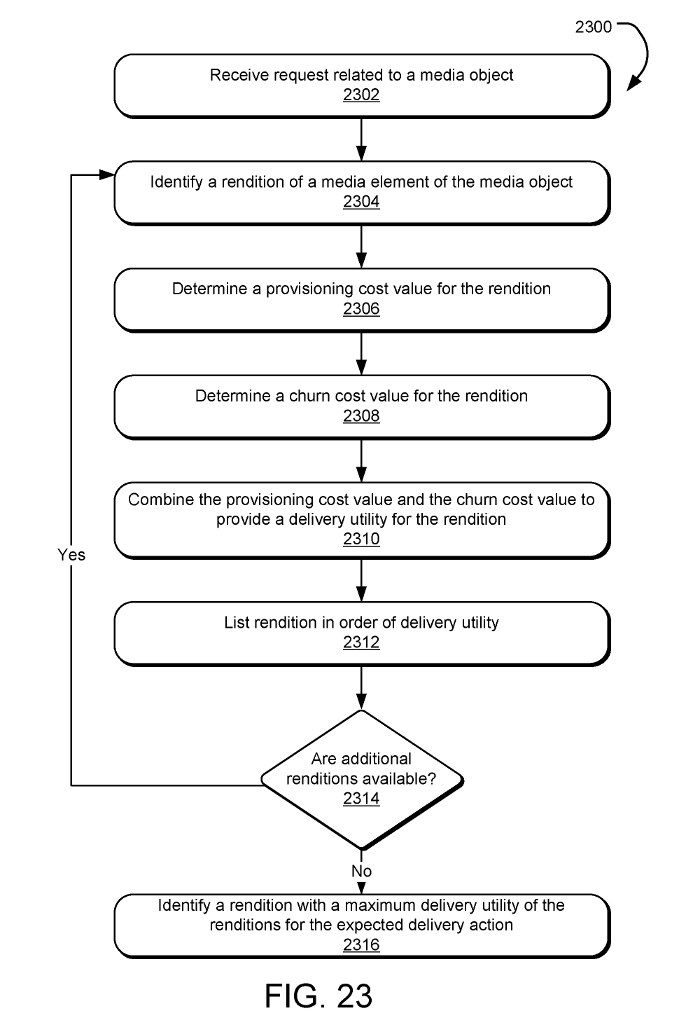

In the context of storage determinations, a delivery utility calculation module 612 may be provided for determining expected actions for one or more model scenario. The expected actions may be utilized in determining storage utility for renditions as described in greater detail below. The delivery utility calculation module 612 may calculate a delivery utility for each of a plurality of renditions that would be selected for delivery in different model scenarios. Once the delivery utility for each available rendition of the media object has been calculated by the delivery utility calculation module 612, the request processor 610 may determine which of the renditions would be served to a user terminal based on the respective delivery utilities of the available renditions for a given model scenario of a plurality of model scenarios. The delivery utility of a determined rendition for the others of the plurality of model scenarios may also be determined, as discussed in greater detail below. The deliver utility calculation module 612 may calculate delivery utility for one or more renditions in a model scenario based on the processes described below in relation to FIGS. 23-25. As discussed below, the delivery utility of an expected action in a model scenario may be utilized to generate storage utility values for different renditions of a media object. The storage utility values may be utilized in determining rendition upgrade values that may be used in making storage decisions for a content cache.

The request processor 610 may interface with the content traffic module 614 to determine whether a rendition is available in the provider content store 618. In some instances, the content traffic module 614 may make a request to the content distribution network 624 or another source of the media object to retrieve the selected rendition to be provided to the multicast communication interface 606.

The provider media module 600 may also include a storage manager 630. The storage manager 630 may be in operative communication with one or more user terminals via the unicast communication interface 602. As described above, in some examples, a storage manager 518 local to the user terminal 500 may make storage systems for a user content cache 512. In other examples, the storage manager 630 of the provider media module 600 may assist a local storage manager 518 or may remotely make storage determinations for a user content cache 512. As such, the storage manager 630 may include a user behavior prediction model 632 that provides functionality as described above in relation to the user behavior prediction model 526. In this regard, the user behavior prediction model 632 may receive historical user behavior data from one or more use monitors of user terminals that may be utilized to train the user behavior prediction model 632. As such, the storage manager 630 may utilize the trained user behavior prediction model 632 for making storage decisions that may be communicated to the storage manager of a user terminal that may carry out the storage decisions as remotely determined at the storage manager 630. Also, the storage manager 630 may make storage decisions for the provider content store 618 using the example methods described herein.

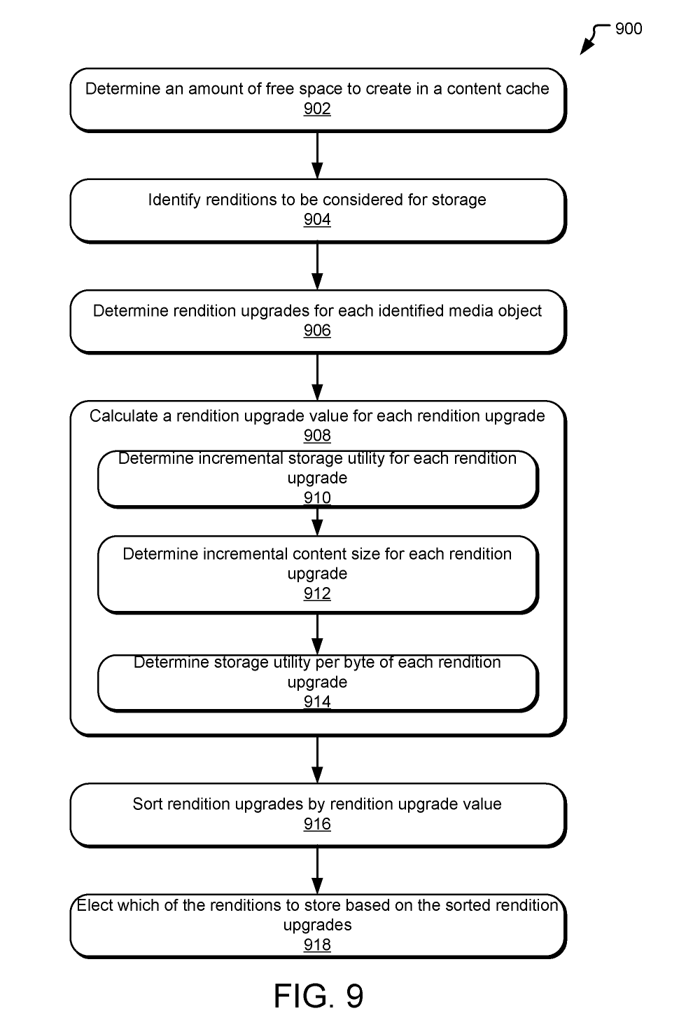

As noted above, management of a content cache, such as a user cache at a user system, may optimize the value of content stored in the content cache. FIG. 9 illustrates an example method 900 for making storage elections of media object renditions in a content cache. As noted above, the discussion of FIG. 9 may generally refer to a video rendition. In this regard, while the discussion may involve the evaluation of renditions of a video element of a media object, it may be appreciated that the discussion is equally applicable to any rendition of any type of media element of a media object. In this regard, the use of the term “video rendition” is not intended to limit the discussion to a given type of media element rendition but is rather provided for explanatory purposes.

A determining operation 902 may be performed to determine an amount of free space to be created or maintained in the content cache. The determining operation 902 may be performed in response to detecting an eviction trigger. The eviction trigger may relate to an amount of occupied storage of the content cache satisfying a storage threshold. For example, if the used storage capacity of the content cache exceeds the storage threshold (e.g., less than a given amount of free space remains unused), the eviction trigger may be detected, and a process for content eviction may commence. The amount of free space to create may be equal or greater to an amount in which the used capacity exceeds the storage threshold or may be a predetermined amount. In some examples, the eviction trigger may be a periodic temporal trigger, which corresponds to the eviction trigger occurring at some time interval (e.g., daily, every 9 hours, every 6 hours, hourly, etc.) In still other examples, an eviction trigger may comprise receipt of a media content object (e.g., a rendition thereof). For example, an eviction trigger may be created upon receipt of prepositioned media content at the content cache or may be created if the storage of prepositioned media content would result in the used capacity satisfying the storage threshold. As such, the method 900 for making storage elections of media object renditions may be made relative to existing content in the content cache or may be performed prospectively for anticipated or received content data to determine whether to store the anticipated or received content data in the content cache.

The method 900 may also include an identifying operation 904 in which video renditions that are subject to the storage decision are identified. As noted above, the renditions identified in the identifying operation 904 may include stored renditions already in the content cache. Additionally or alternatively, the renditions identified in the identifying operation 904 may be received content (e.g., prepositioned content referred to above) that, while not yet stored in the content cache, may be stored based on the outcome of the storage decision.

A determining operation 906 may determine rendition upgrades for each identified video rendition of a media object from the identifying operation 904. Each rendition identified in operation 904 corresponds to a media object. Operation 904 may identify rendition upgrades for each such media object. As may be appreciated in the discussion below, storage decisions for content in the content cache may be made relative to rendition upgrades that are available or could be available in the content cache. In this regard, a given media object may have a plurality of rendition upgrades available if a plurality of renditions of the media object are stored. As will be further appreciated below, a rendition upgrade may also be evaluated between a rendition and a null rendition, which may be modeled as no rendition of the media object being stored in the content cache.

As used herein, the term rendition upgrade for a particular rendition of a media object typically is used to refer to a higher rendition of the particular rendition available for storage in the local cache in place of the particular rendition. Typically, as used herein, the term rendition-upgrade pair refers to a lower version of a particular rendition of a media object paired with an available higher version (a rendition upgrade) of the particular rendition, where the lower rendition may include a null rendition in which no version of the particular rendition is stored in the cache. As should be apparent from context, the term rendition upgrade may also be used to refer to a rendition-upgrade pair. In addition, the lower rendition in a rendition-upgrade pair may be referred to as a downgrade or a downgrade option. A ”higher” rendition can be any of the following compared to a “lower” rendition: (1) provides greater resolution or quality for the user (e.g., a higher bit rate), or (2) transmission over a network utilizes more network resources.

In some embodiments, rendition upgrades for a media object can be determined as follows. Initially, a rendition upgrade can be created from null (no rendition of the media object) to each of one or more (e.g., all) of the available renditions of the media object identified at operation 904. Each such rendition upgrade represents an upgrade from null to one of the available renditions. Additional rendition upgrades can be created from one or more (e.g., each) of the renditions identified at 904 to one or more (e.g., all) of the available higher renditions. Each such rendition upgrade represents an upgrade from a lower available rendition (including null) to an available higher rendition.

The method 900 further includes a calculating operation 908 in which a rendition upgrade value for each rendition upgrade is determined. As shown in FIG. 9, the calculating operation 908 may include a determining operation 910 in which an incremental storage utility for each rendition upgrade is determined, a determining operation 912 in which an incremental size for each rendition upgrade is determined, and a determining operation 914 in which the rendition upgrade value for a rendition upgrade is determined by dividing the incremental storage utility by the incremental size for the rendition upgrade.

The method 900 may also include a sorting operation 916. In the sorting operation 916, the rendition upgrades may be sorted based on the determined rendition upgrade value for each rendition upgrade. The sorted rendition upgrades from the sorting operation 916 may be used in an electing operation 918 in which renditions are elected to be stored based on the sorted rendition upgrades. For example, the electing operation 918 may include opting to store or not store a received rendition (e.g., that has been prepositioned from the service provider) and/or may include determining whether to evict content that was stored in the content cache prior to initiating the method 900.

The electing operation 918 may include establishing a minimum rendition upgrade threshold or eviction line. The minimum rendition upgrade threshold or eviction line may be a predetermined value for a content cache. Alternatively, the minimum rendition upgrade threshold may be determined in relation to the amount of storage space to be freed with eviction. For example, the minimum rendition upgrade threshold may be set to a rendition upgrade value such that all rendition upgrades falling below or that fail to meet the minimum rendition upgrade threshold equals the amount of storage space to be freed in an eviction process.

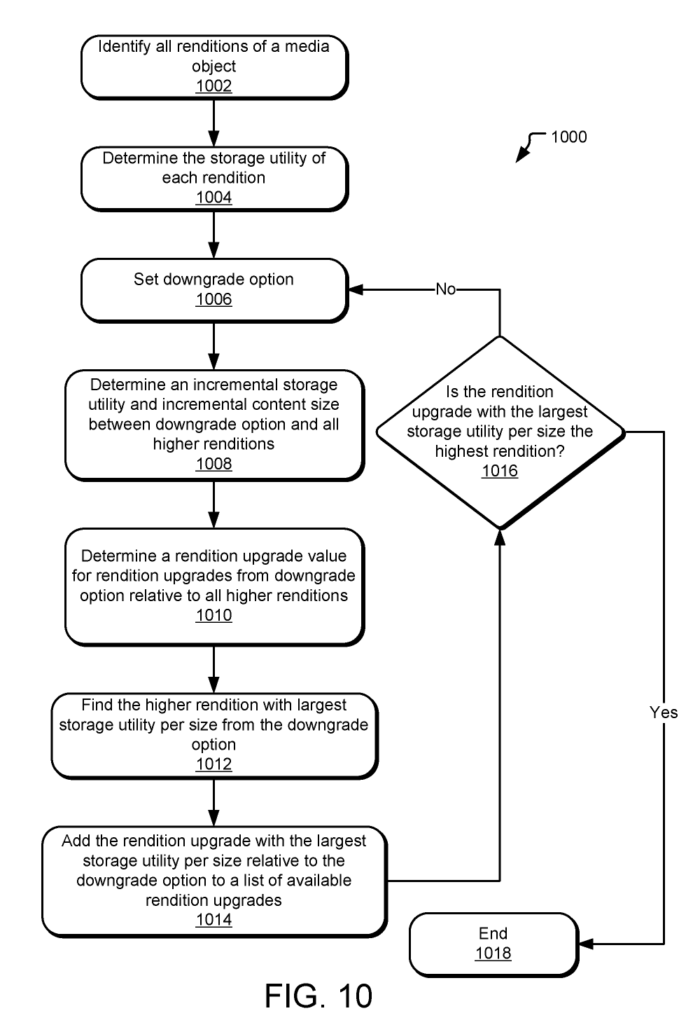

FIG. 10 illustrates a method 1000 for determining rendition upgrade values for rendition upgrades of a media object (e.g., the media object referenced at 906 of FIG. 9). In this regard, the method 1000 presents an example of the determining operation 906 and the calculating operation 908 operating with respect to one of the identified media objects referenced in operation 906. As discussed in greater detail below in a specific example, the method 1000 may allow for the evaluation of rendition upgrades such that rendition upgrades between a plurality of renditions for a given media object may be collapsed to provide rendition upgrades in a sorted list of rendition upgrades that are monotonically decreasing in terms of rendition upgrade value. That is, if a higher rendition provides a greater rendition upgrade value than a relatively lower rendition, the rendition upgrade to the relatively lower rendition need not be considered for storage as the higher rendition may represent a better utilization of storage.

The method 1000 may initially include an identifying operation 1002 in which renditions (e.g., all) for a given media object (e.g., an identified media object referenced in 906 of FIG. 9) that are stored or are candidates for storage are identified. As described above, this may include identifying stored renditions in the content cache or may include received data that has not yet been cached in the content cache (e.g., that has been provided unsolicited to the user system).

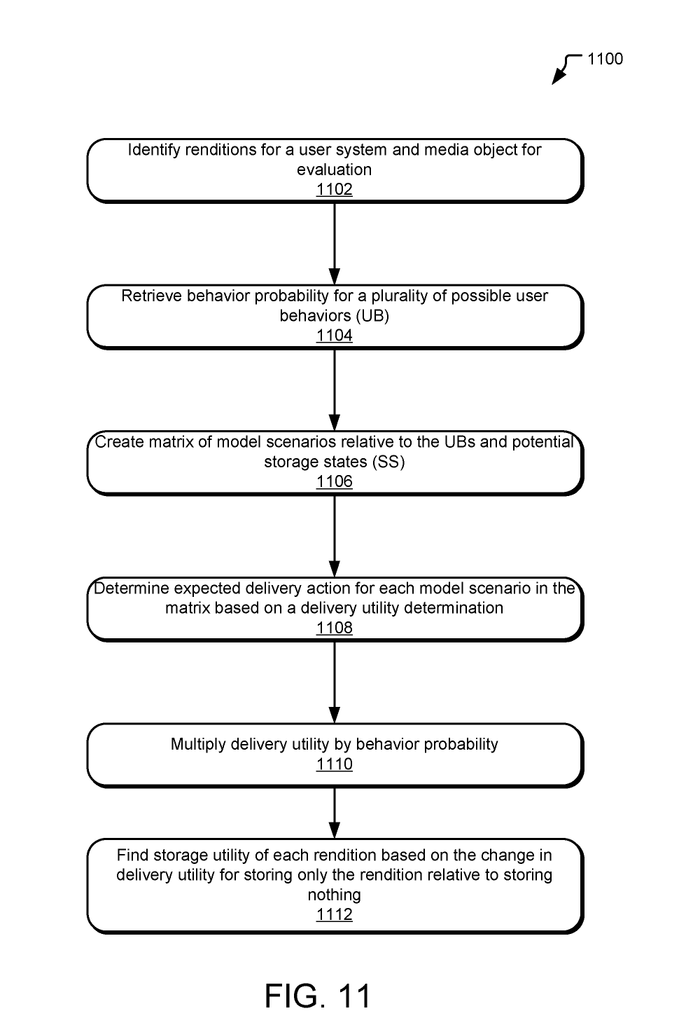

The method 1000 may also include a determining operation 1004 in which the storage utility for each identified rendition is determined. The storage utility for a rendition may be generated according to a method 1100 as described below in FIG. 11. While the determining operation 1004 may return the respective storage utilities for the renditions, the rendition upgrade value may represent the incremental value for each rendition upgrade rather than an outright storage utility of a rendition. That is, use of the rendition upgrade value may determine whether the incremental value achieved from maintaining a higher-resource rendition of a media is enough to make up for content that would be evicted due to the incremental content size of the higher-resource rendition.

The method 1000 may, therefore, be iterative over each determined rendition upgrade available based on the renditions identified in the identifying operation 1002. In relation to the evaluation of each rendition upgrade, at operation 1006, a downgrade option for a rendition upgrade may be set. As the method 1000 iterates over all available rendition upgrades, the downgrade option may also be iterated. Initially, at operation 1006, the downgrade option may be set to a null rendition, which represents no rendition for the media object being stored. Generally, the downgrade option may represent the less resource-intensive rendition of a rendition-upgrade pair with a rendition upgrade representing a relatively more resource-intensive rendition (e.g., higher quality rendition) relative to the downgrade option. As noted, in the first pass through operation 1006, the downgrade option may be a null rendition. In any (e.g., all) subsequent passes through operation 1006, the downgrade option can be the rendition upgrade added to the list as part of the immediately preceding performance of operation 1014.

At a determining operation 1008, an incremental storage utility between the downgrade option and each rendition upgrade is determined. By rendition upgrade, it is meant any rendition that is relatively more resource intensive (e.g., higher bandwidth, higher bitrate, etc.) than the downgrade option. For example, the available renditions evaluated may comprise different bit rate renditions for a given title and format of a media object. However, in other examples, additional attributes of the downgrade option and rendition upgrade may be considered in determining the relative resource usage of the renditions. However, returning to the simplified example using bit rate differences, renditions with bit rates greater than the downgrade option may be considered as rendition upgrades, and the incremental storage utility of each such rendition upgrade may be determined relative to the downgrade option. The incremental storage utility may be calculated as a difference between the storage utility of each rendition upgrade and the storage utility for the downgrade option. Also, at determining operation 1008, an incremental content size between all rendition upgrades and the downgrade option may be determined. This may be calculated as a difference between the size on disk of each rendition upgrade and the size on disk of the downgrade option.

At operation 1010, a rendition upgrade value comprising an incremental storage utility per incremental size is determined for each rendition upgrade relative to the downgrade option. That is, for each rendition upgrade that is available for the media object relative to the downgrade option, the incremental storage utility between the rendition upgrade and the downgrade option may be divided by the incremental size between the rendition upgrade and the downgrade option. At operation 1012, the rendition upgrade with the largest rendition upgrade value relative to the downgrade option determined at operation 1006 for the current iteration is found from all of the available rendition upgrades. At operation 1014, this rendition upgrade having the largest rendition upgrade value relative to the downgrade option is added to a list of available rendition upgrades.

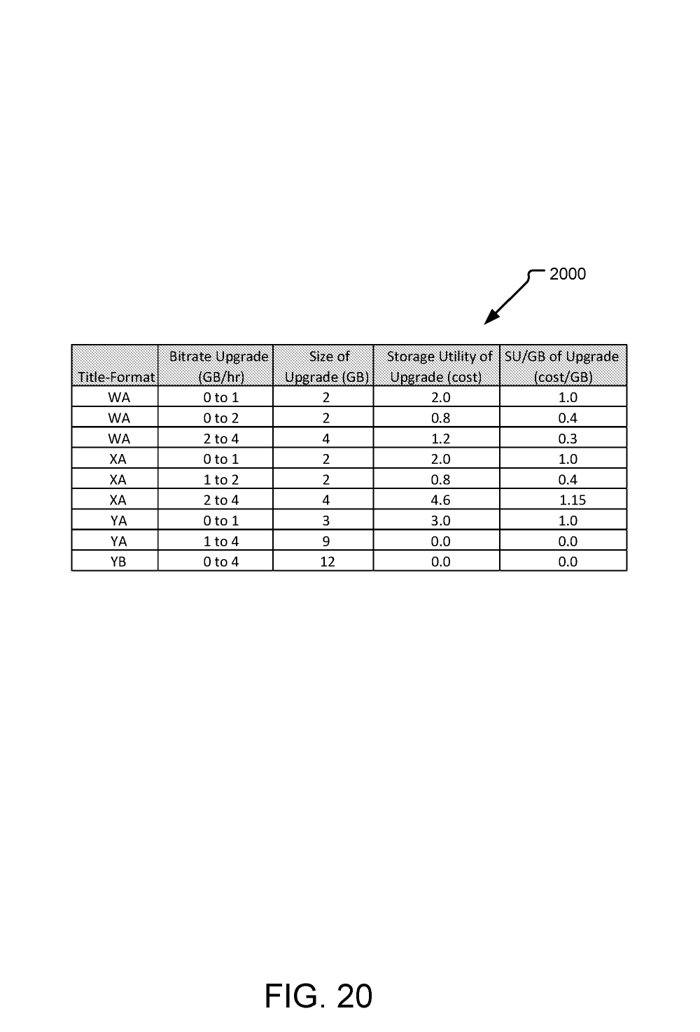

As noted above the method 1000 may be iterative. As such, at operation 1016, it may be determined whether the added rendition upgrade added to a list of available rendition upgrades from the prior iteration (e.g., the rendition upgrade having the largest rendition upgrade value relative to the downgrade option from the prior iteration) is the highest (e.g., highest resource-intensive) rendition upgrade available from the rendition upgrades in the content cache. For example, it can be determined at operation 1016 whether the rendition upgrade added to the list of available rendition upgrades at 1014 meets a predetermine criteria (e.g., is the highest rendition identified at 1002 for the media object). If the added rendition upgrade from the prior iteration does not meet the criteria (e.g., is not the greatest rendition upgrade in the content cache for the media object), then the method 1000 may iterate back to operation 1006, where the added rendition upgrade from the prior iteration is set as the downgrade option for a subsequent iteration of operations 1006-1016. In contrast, if the added rendition upgrade from the last iteration meets the criteria (e.g., is the greatest rendition upgrade in the content cache, that is, the highest rendition identified at 1002 for the media object), the method 1000 ends at operation 1018, and the rendition upgrades that have been added to the list in operation 1014 (e.g., over all performed iterations) are returned. An example of the method 1000 is illustrated in the specific example below and provides the collapsing of rendition upgrades as shown in FIG. 20.

As noted above, the method 1000 of FIG. 10 includes determining at operation 1004 a storage utility of each rendition identified at 1002. With further reference to FIG. 11, an example method 1100 is shown that may be used to determine a storage utility for one or more renditions of a media object. The method 1100 can be executed at 1004 to produce storage utilities of one or more of the renditions. Alternatively, the method 1100 can be executed in advance to produce the storage utilities, which can be stored for later access by operation 1004 of FIG. 10. As yet another alternative, the method 1100 can be executed at 1004 to update previously stored storage utilities.

Regardless, the method 1100 may initiate at an identifying operation 1102 in which renditions for a given user system and media object are identified for processing to determine storage utility values thereof. For purposes of simplicity in explanation, the renditions described herein may vary with respect to a bit rate such that different bit rate renditions may be evaluated for a media object. However, it may be appreciated that other differences in attributes of the renditions of a media element may be provided in the renditions that are evaluated using the approach described herein.

In an operation 1104, behavior probabilities are retrieved regarding a plurality of possible user behaviors. The plurality of possible user behaviors may correspond to potential consumption activities for the media object. For example, the possible user behaviors may correspond to a household not consuming the media object, a household consuming the media object on a small screen (e.g., a smartphone or the like), a household consuming the media object on a medium screen (e.g., a small television, tablet device, etc.), or a household consuming the media object on a large screen (e.g., a projector, large television, etc.). The definitions for each of these possible user behaviors may be predetermined such that screens of various sizes may be categorized into the small, medium, and large categories. In addition, it will be assumed that if the content is to be viewed on more than one screen size, the analysis here will treat the larger screen size as controlling the analysis. The behavior probability of each of these possible user behaviors for the media object may be generated based on a user behavior predictive model as will be described in greater detail below.

While these possible user behaviors are provided for illustration purposes, it may be appreciated that other possible user behaviors may be considered in the method 1100, such that additional or fewer user behaviors associated with a corresponding behavior possibility may be utilized. In addition, other possible user behaviors other than those related to playback device screen size may be contemplated, such as possible user behaviors associated with different playback devices that have varying capabilities with respect to other media element renditions such as audio encoding capability, video encoding capability, video resolution capability, etc.

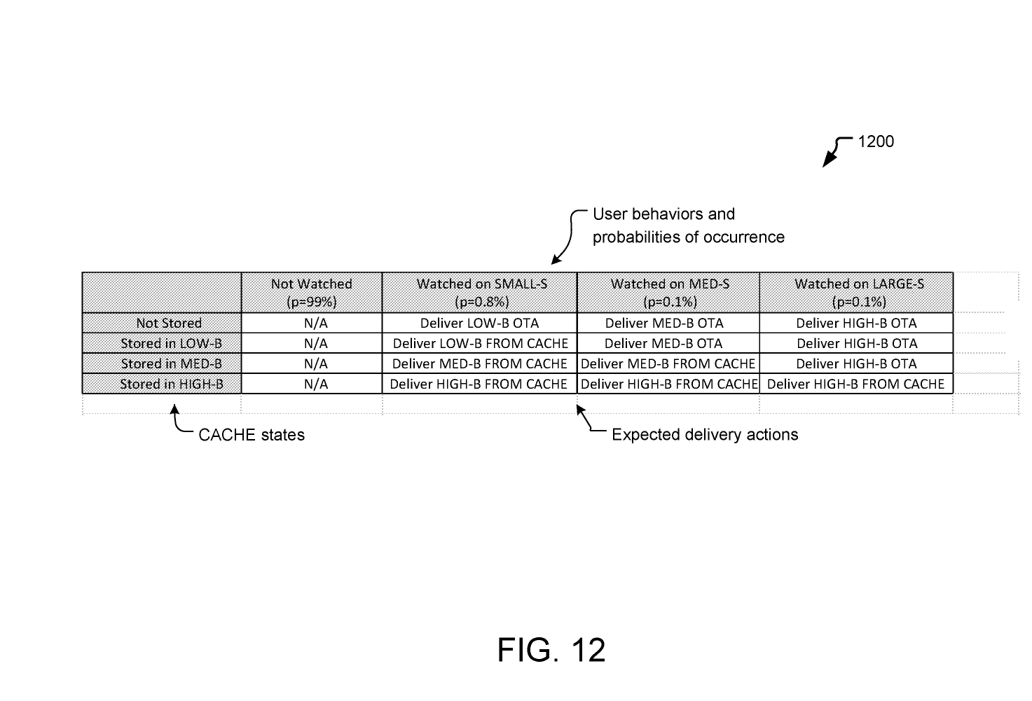

In operation 1106, a matrix may be created that defines a plurality of model scenarios. The plurality of model scenarios may be defined relative to the possible user behaviors and potential storage states for the content cache under consideration. However, it may be appreciated that model scenarios may extend into further dimensions such that additional variables may be considered, such as, potential network conditions, aggregated client-side statistics (e.g., overall content popularity or the like), different potential time periods, content provider preferences, or other variables associated with consumption of the media object. An example of a matrix 1200 is shown in FIG. 12. In the matrix 1200, the columns represent the possible user behaviors, as can be seen with the column headings of not watched, watched on small screen, watched on medium screen, and watched on large screen. In addition, each possible user behavior is also shown with a behavior probability for the respective user behavior, shown as p in FIG. 12. As noted above, these behavior probabilities (p) may be provided from a user behavior prediction model, an example of which is described in more detail below. In the illustrated example, there is a 99% probability that the content will not be watched, a 0.8% probability that the content will be watched on a small screen, a 0.1% probability the content will be watched on a medium screen, and a 0.1% probability the content will be viewed on a large screen.

The rows of the matrix 1200 may represent different storage states of the content cache being considered. Thus, various storage states are represented, including that no rendition of the media object is stored, that a low bitrate rendition of the media object is stored, that a medium bitrate rendition of the media object is stored, and that a high bitrate rendition of the media object is stored.

In operation 1108, an expected delivery action may be determined for each model scenario of the matrix 1200 representing different respective combinations of storage state and user behavior. In turn, the cells of the matrix 1200 represent the expected delivery actions for the given model scenario. These expected delivery actions may include an identification of which rendition would be modeled to be delivered and whether the rendition in the model scenario would be delivered from the content cache or via an over-the-air transmission (e.g., over a shared forward link). The expected delivery actions may be determined as a rendition having the greatest delivery utility for the proposed model scenario. As will be described in more detail below, the delivery utility of a rendition may be based on the provisioning costs and churn costs for delivery of the rendition for the given model scenario of the matrix. In other examples, the expected delivery of a rendition may be determined (e.g. predetermined based on logic associated with the given model scenario) and the delivery utility of the rendition in that case may be determined. In any regard, a corresponding delivery utility may also be provided for a rendition in each expected delivery action.

In operation 1110, the corresponding delivery utility for each expected delivery action may be multiplied by the behavior probability for the corresponding possible user behavior. This may provide a behavior-modified delivery utility for each model scenario. In turn, at operation 1112, the storage utilities for each rendition corresponding to the expected delivery action for each model scenario may be determined as the difference between the behavior-modified delivery utility for the rendition relative to a delivery utility associated with storing no rendition.

As noted above, the determination of the storage utility may involve behavior probabilities for one or more possible user behaviors. In this regard, operation 1104 may include executing a user behavior prediction model to obtain behavior probabilities for one or more possible user behaviors. The user behavior prediction model may be a supervised machine learning model that is trained using historical user behavior data (e.g., obtained by one or more use monitor 516 of corresponding user systems). The historical user behavior data may be transformed into labeled training data that relates observed historical user behavior to feature vectors comprising predictor variables for media objects in the observed historical user behavior. In turn, possible user behaviors regarding a media object may be modeled by the user behavior prediction model to provide behavior probabilities as described above in relation to the matrix 1200.

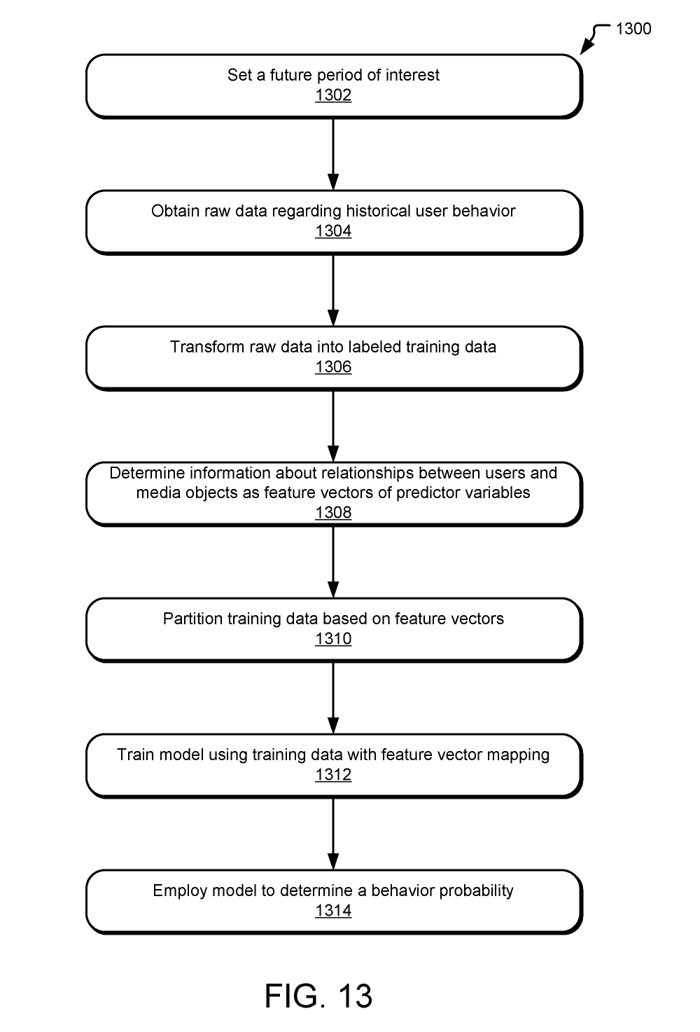

FIG. 13 illustrates an example method 1300 that may be used to train and implement the user behavior prediction model. The method 1300 may initiate with an operation 1302 that sets a future period of interest. The future period of interest relates to a prospectively looking time period in which the possible user behaviors may occur. For example, in a satellite communication system, it may be assumed that opportunistic content delivery may be provided in off-peak time periods, which may roughly occur overnight each day. That is, an expected surplus of network resources may be expected every day in which prepositioned content in the content cache may be updated. As such, storage decisions for a content cache may be relevant for a given period until different content may be opportunistically delivered. Such off-peak time periods may be cyclical on a 24 hour period. As such, in one example, the future period of interest may be 24 hours. However, in other examples, other periods may be provided such as those tied to different cycles for opportunistic delivery of content.

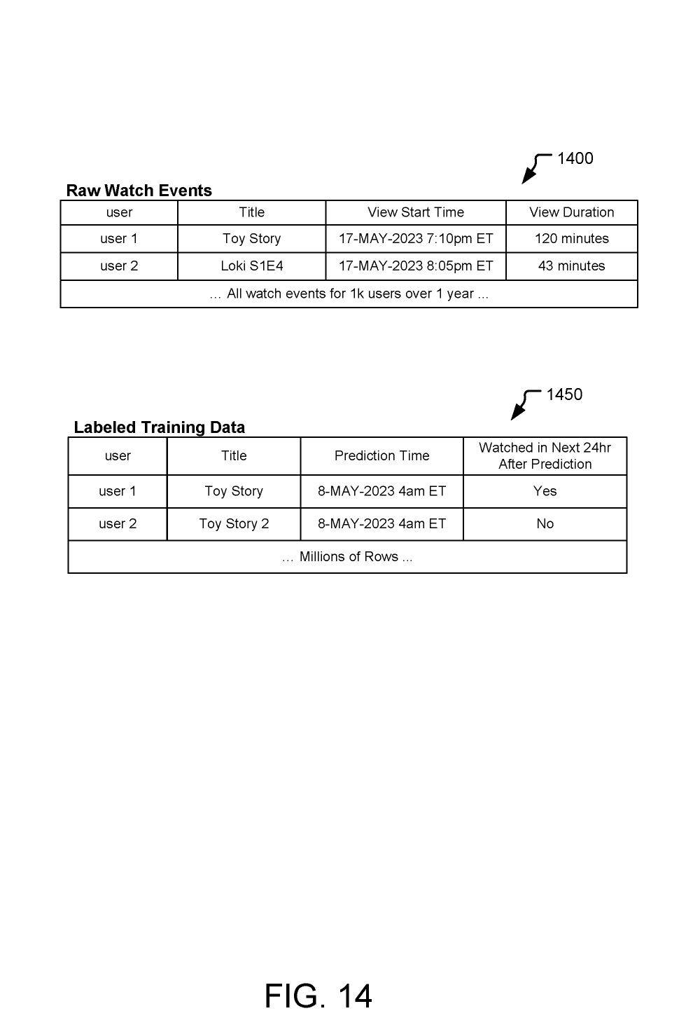

An operation 1304 may include obtaining raw data regarding user behavior. As noted above in the discussion of the use monitor 516, the raw data regarding user behavior may be specific to a given user system or may include aggregated data from the use monitors of a plurality of user systems. The operation 1304 may include collecting, aggregating, and/or otherwise processing data from the use monitor of one or more user systems in a communication system. The raw user behavior data may be anonymized such that content consumption information relative to one or more feature vectors may be obtained but may not be linked to any given user system or user. FIG. 14 shows one example of raw data 1400 regarding historical user behavior. As may be appreciated, the raw data 1400 may include a listing of watch events for a plurality of user systems of the communication system that includes the media object consumed, the time at which the media object is viewed, the view duration, or other data regarding historical media consumption.

In an operation 1306, the raw user behavior data 1400 may be transformed into labeled training data. This may include identifying one or more timestamps in the historical user behavior data. For each combination of user, media object, and timestamp, a labeled training data entry may be created as shown in the labeled training data 1450. That is, for a given user, media object, and time stamp, the labeled training data 1450 may include an indication of whether the user watched the media object within the future period of interest from the timestamp.

Moreover, the labeled training data may be appended with additional information that may assist in predicting future possible user behavior. Such information may be referred to as feature vectors. The feature vectors may comprise predictor variables. As such, some feature vectors may be generated for specific metadata regarding a media object. These feature vectors comprising predictor variables may be used to supplement or isolate predictor variables that are found to impact user behavior for a given media object or type of media object. For example, some factors relevant to the probability of a given user watching a media object may include whether the user has engaged with the media object, how popular the media object is (e.g., generally from external ratings or viewership data or based on other user system consumption in a communication system), the amount of content the user has consumed historically, a number of users with similarity (e.g., related to historical user behavior, demographics, geographic location, or other metric) to the user that has consumed the media object, a genre affinity for the user, a cast affinity for the user, when the user last engaged with the media object, a state of progress of the user relative to a set of media objects (e.g., where the media object relates to a last viewed episode of a series), etc. A genre affinity may relate to a user’s previous interaction with media objects having a given genre, which may be represented in metadata for the media object. A cast affinity may relate to a user’s previous interaction with cast members for a given media object, which may also be represented in metadata for the media object. In addition, the type of media object may be considered, including whether the media object comprises episodic content (e.g., episodes in a series) or unitary content (e.g., stand-alone content such as a movie or the like).

Feature vectors may be provided that relate to whether the media object comprises a movie, a series, or other content. Feature vectors may be provided relating to whether the media object comprises “engaged” and “unengaged” content. Definitions regarding engaged and unengaged media objects may be predefined. That is, parameters defining what constitutes “engaged” or “unengaged” may be predetermined. For instance, a series may be “engaged” if a user has consumed an episode of the series in the last two weeks. In one example, an engaged media object comprises a media object that has been previously viewed or belongs to a set of content that has previously been viewed (e.g., an episode of a series for which a user system has watched other episodes of the series). While these specific feature vectors are used herein for explanation, it may be appreciated that additional and/or different feature vectors relating a media object to potential user behavior may also be utilized without limitation.

At operation 1308, determinations may be made regarding information about the relationship of the media object to the user. This may include identifying one or more feature vectors comprising predictor variables. In the illustrated examples, this may include determining whether the media object is engaged content or unengaged content and may include determining whether the media object is a movie, series, or other content.

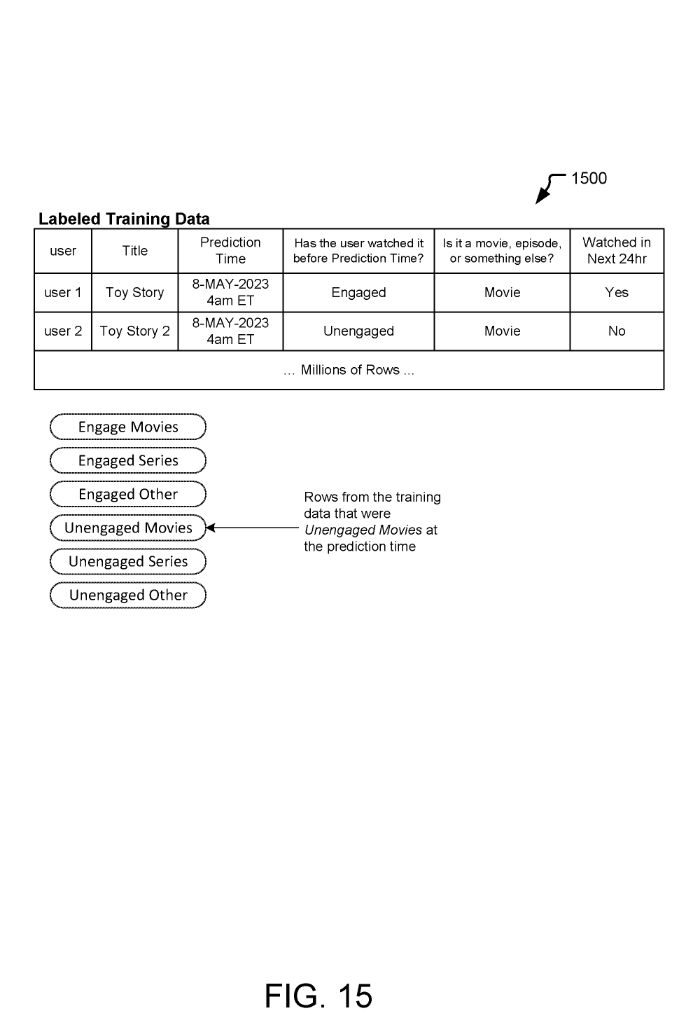

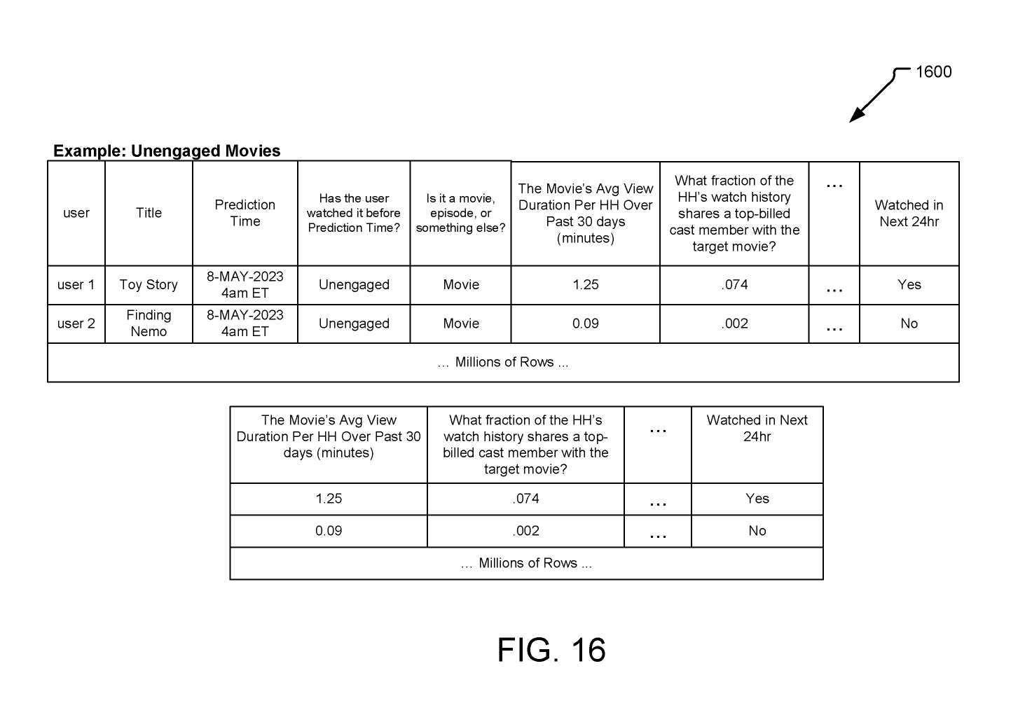

In turn, the labeled training data may be partitioned in operation 1310. This may include isolating or selecting entries from the labeled training data that correspond to one or more determined feature vector from operation 1308. For example, if a media object is determined to be an unengaged movie (e.g., movie content that a user has not previously viewed), then similar entries from the labeled training data may be selected related to historical user behavior for unengaged movies. In turn, this partitioned labeled training data based on the identified feature vector may be used to train an instance of the user behavior prediction model for the given media object sharing the feature vector with the partitioned training data. For example, FIG. 15 shows labeled training data 1500 that is selected for partitioning in operation 1310 based on an associated feature vector for unengaged movies. Additionally, FIG. 16 illustrates labeled training data 1600 with expanded predictor variables for the feature vector associated with the unengaged movie including the movie’s average view duration per household over the past 30 days, a cast affinity predictor variable (e.g., a fraction of the household’s watch history that shares a cast member with the target movie), or other specific predictor variables related to the isolated feature vector.

In turn, the predictor variables for the partitioned feature vector of the partitioned training data may be used to train the user behavior prediction model in a training operation 1312. The training operation 1312 may include use of the training data to train a supervised machine learning model such as a support-vector machine, a neural network, a random forest, or other machine learning approach. As noted above, this training operation 1312 may include creating an instance of the user behavior prediction model specific to a given media object based on identified feature vectors for the media object. To further this example, a first instance of the user behavior prediction model may be trained using first partitioned training data having a first feature vector for an engaged movie and a second instance of the user behavior prediction model may be trained using second partitioned training data having a second feature vector an unengaged series.

Once the model has been trained, the method 1300 may include a modeling operation 1314 in which a corresponding instance of the trained user behavior prediction model is applied to determine one or more behavior probabilities for possible user behaviors, such as those described above in relation to the matrix 1200.

### EXAMPLE

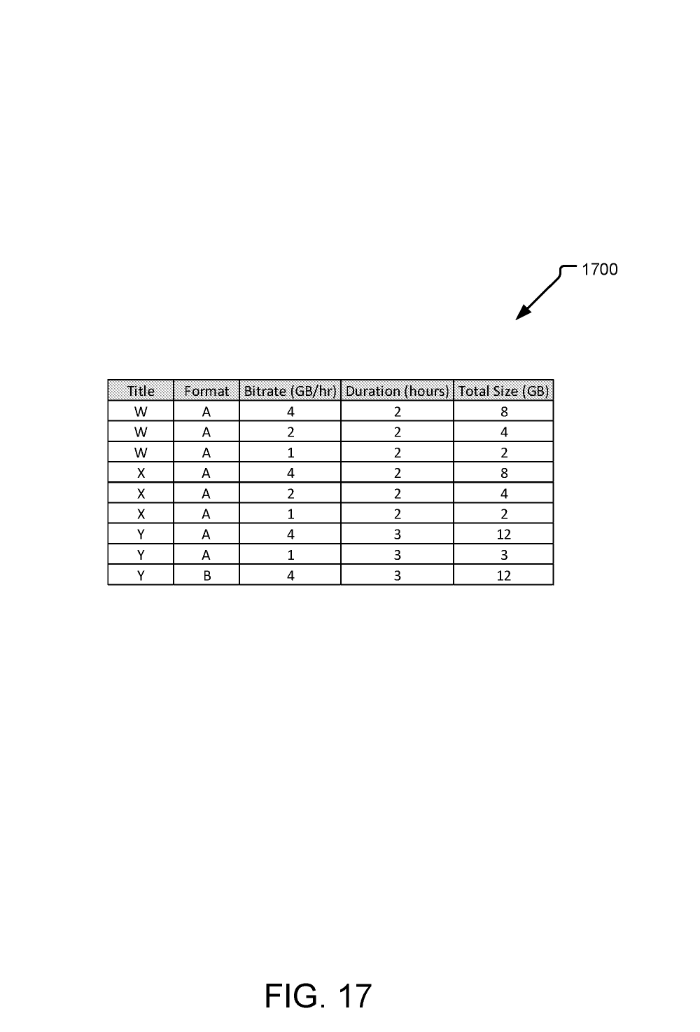

FIGS. 17-22 relate to an example illustrating the eviction of media object data from a content cache using an example of the present disclosure. The example can be performed on a media system such as any of the example media systems illustrated herein and/or in accordance with processes illustrated herein. FIG. 17 illustrates stored content for a content cache. In this example, the content cache may be a user cache of a user system. The user cache currently has 55 GB of content 1700 as shown in FIG. 17. The content 1700 is listed with regard to title, format, and bitrates, with each row of the chart representing a different rendition of a media element of a media object. That is, each row of the content 1700 may represent a different rendition of media objects WA, XA, YA, and YB respectively. In the illustrated example, the objective is to evict the least valuable 40 GB of content, such that only 15 GB of content remains on the user cache.

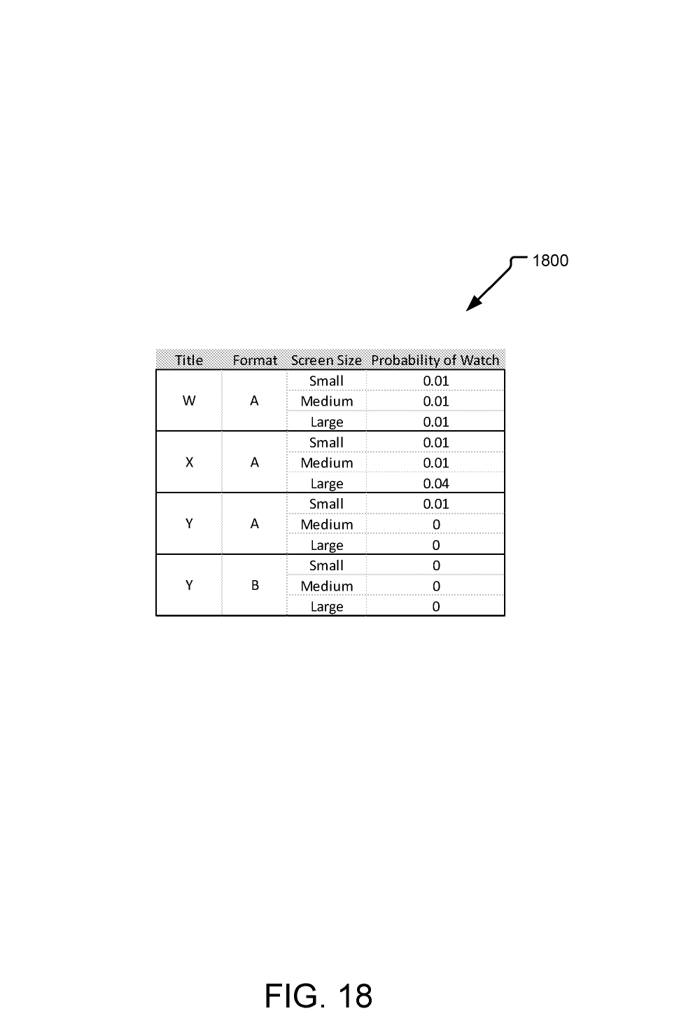

As noted above, the behavior probability for a plurality of user behaviors may be determined for the renditions under consideration. For example, using the method 1300 of FIG. 13, probabilities of watch for each rendition stored in the user cache may be determined as shown in the probability of watch table 1800 of FIG. 18. Such a model can be previously trained, for example, by operations 1302-1312. The probabilities of watch mentioned above can then be determined by operation 1314. As shown in FIG. 18, the watch table 1800 may include behavior probabilities comprising probability of watch for each title and format combination relative to user devices having a small, medium, and large screen.

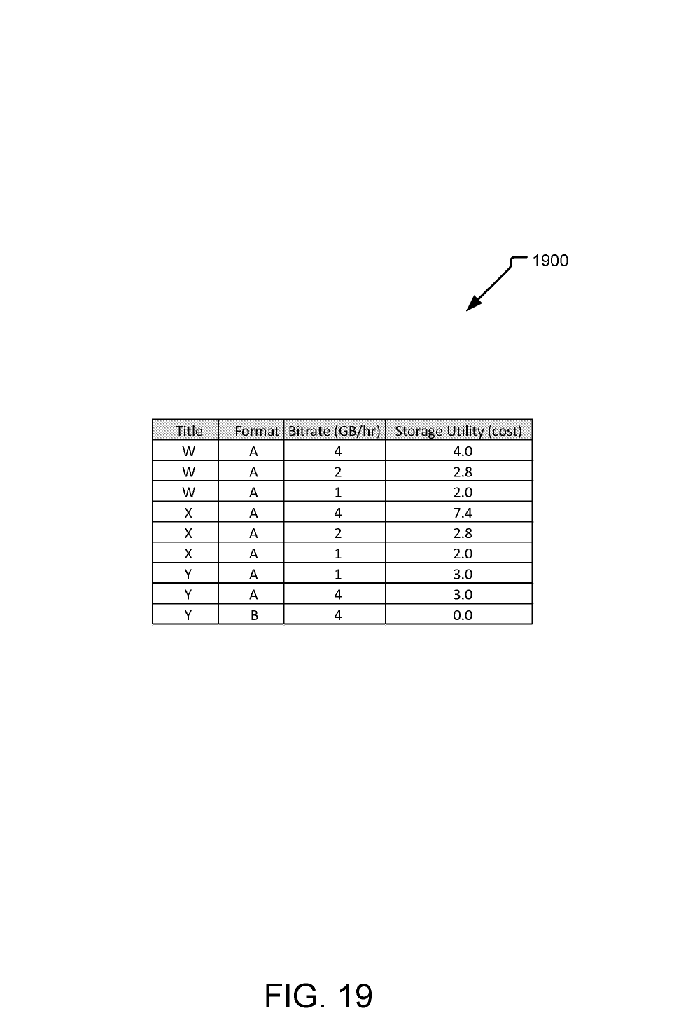

In addition, the storage utility of each stored rendition (e.g., of each stored title-format-bitrate) may be determined. The storage utility for each stored rendition is represented in the storage utility table 1900 in FIG. 19. For conciseness, the renditions will be referenced in an abbreviated manner taking the form of title W in format A at a 4 GB/hr bitrate as WA-4. The storage utility of WA-4 for the user associated with the user cache represents the total value to a service provider of having WA-4 stored on the user cache relative to the user cache not storing any rendition for the title-format of WA. As noted above in relation to FIGS. 11-12, to determine the storage utility, a matrix representing an expected delivery action table is created (e.g. including what action would be made if the user were to watch WA on a given screen size and the user cache had a given storage state in a given format including whether the rendition would be delivered from the user cache or be served over the air). The expected delivery utility for each model scenario in the matrix is determined (e.g., if the user watched WA on a large screen and the 1 GB/hr bitrate rendition is stored, a 4 GB/hr bitrate version would be delivered over-the-air due to a higher delivery utility for the WA-4 rendition). This delivery utility represents the total value for the delivery action in terms of the network resources used and the impact on the probability of the user churning off the provider service relative to the user not having watched WA at all, as further elaborated on in FIGS. 20-25 below. In turn, the expected delivery action matrix, the associated delivery utility of each model scenario in the matrix, and the probability of the user watching WA on each possible screen size is used to determine the expected delivery utility of each storage state (including "Not Stored").

For the sake of an example, assume WA is not stored at the user cache, and there is a 1% chance of the user watching WA on a small screen. If that happens, WA-1 would be delivered over-the-air (OTA). In the illustrated example, assume this delivery would “cost” the service provider about 10 cost units in bandwidth costs and the user’s churn impact, resulting in a delivery utility of 10 cost units. Because there is a 1% chance of this happening, this model scenario contributes -0.1 cost units of expected delivery utility. This process is repeated for other possible user behaviors including the user watching WA on a large and medium screen. In turn, these values may be summed to get the total expected delivery utility of the Not Stored state for WA on the user cache. This is then also repeated for the other storage states: WA-1 (i.e. the state where the 1 GB/hr copy of WA is stored on the user cache), WA-2, and WA-4. These values are then normalized by subtracting the expected delivery utility of the Not Stored state from the expected delivery utility of each other storage state. This provides non-negative storage utilities for WA-1, WA-2, and WA-4 in the user cache, as shown in the storage utility table 1900 of FIG. 19. These storage utilities may represent the total value to the service provider of having a rendition stored in the user cache relative to having no rendition for the corresponding title-format in the user cache. Note that, as used herein, a cost unit can be any measure or estimate of a cost, including, for example, a monetary measure (e.g., “cents”).

The storage utility table 1900 indicates that it is worth 4 cost units to the service provider to have WA-4 stored in the user cache compared to not having any copy of WA stored in the user cache. This 4 cost unit value comes from probabilistically-weighted bandwidth savings and reduction in customer churn. The storage utility values in this example are simply illustrative and may not be in the correct order of magnitude for the probabilities shown above.

In addition, the user might watch WA on a large screen. If this happens, and only the 2 GB/hr rendition of WA is stored, the expected delivery action would be to send the 4 GB/hr rendition of WA over the air. Therefore, it is not as valuable to store the 2 GB/hr rendition of WA as the 4 GB/hr rendition. Notwithstanding, because there is a chance the user will watch WA on a medium or small screen, in which case the WA-2 rendition would be delivered from the user cache, there is some value in having WA-2 stored for the user over not having WA stored at all. Hence the storage utility of WA-2 is 2.8 cost units: more than 0, but less than 4.

Similarly to the above, it is possible the user watches WA on a medium or large screen, for which WA-1 would be useless. However, as it is also possible the user watches WA on a small screen, WA-1 would be useful.

The analysis for XA follows the same general pattern as WA. However, because the probability of the user watching XA on a large screen is very high compared to the probability of the user watching XA on a small/medium screen, one can observe a sharp rise in value from XA-2 to XA-4 (unlike with WA, in which there was a smaller rise between WA-2 and WA-4).

In addition, there is a 1% chance the user will watch YA on a small screen, where YA-1 would be used. Note that because Y is longer than X (3 hours instead of 2 hours), one can observe higher storage utilities for Y, given comparable probabilities. This is why YA-1 has more storage utility than XA-1, despite the same small-screen probability of watch for YA and XA. However, Y being longer than X also means it would occupy more disk space, so this will partially cancel out in further steps as shown below. If the user watches YA on a small screen, YA-4 would be just as useful as YA-1 (albeit taking up more space). Because there is no chance that the user will watch YA on a large screen, there is no situation in which YA-4 would be more useful than YA-1. It, therefore, has the same expected delivery utility as YA-1. There is no chance of the user watching YB at all, so all copies of YB have 0 storage utility for the user cache. In other words, it is not worth anything to the service provider to have a copy of YB-4 (or any YB rendition) stored for the user cache as opposed to having nothing stored for the user cache.

Once the storage utilities for each stored rendition have been determined, as shown in FIG. 19, the approach described in the present disclosure may not merely just evict the renditions with the lowest storage utility. Rather, the present disclosure also may consider that it is desirable to keep at most one rendition for a given title-format pair. For example, if both XA-2 and XA-4 are stored, if the user watches XA on any screen size, XA-4 may be served. As such, XA-2 does not provide any incremental value and takes up disk space. If XA-4 is to be kept, eviction of XA-2 and any lower-bitrate copies of XA may be advantageous. The decision to keep XA-4 or XA-2 may be determined based on the probability-of-watch by screen size. For example, if there is a very low chance of the user watching XA on a large screen, it may be advantageous to keep XA-2 and evict XA-4 because these renditions would have roughly the same storage utility and XA-2 would occupy much less space. However, this may not mean that the rendition with the greatest storage utility per byte is kept and other renditions are evicted.

For example, consider a new title V. Assume that VA-2 is 1GB and has 5 cost units of storage utility, whereas VA-4 is 2GB and has 9 cost units of storage utility. VA-2 has more storage utility per byte than VA-4 (5 cost units per GB vs. 4.5 cost units per GB). However, if an upgrade from VA-2 to VA-4 is made (e.g., VA-4 is stored and VA-2 is evicted), that upgrade will cost 1 GB of storage space and provide 4 additional cost units of storage utility. That upgrade is therefore worth 4 cost units per GB. In addition, the upgrade may be worth more per GB than storing some other low-probability rendition of a media object. In that case, it may be advantageous to store VA-4 and evict some other low-probability rendition of a media object. In this case, it would also be advantageous to evict VA-2 because VA-4 could be used for any screen size.

To summarize, when making a determination of which renditions to evict, the present disclosure does not simply evict the renditions with the lowest storage utility. As the present disclosure typically keeps at most one rendition (e.g., bitrate) per title-format, rather than just keeping the highest stored bitrate for a given title-format and evicting the rest, the present disclosure contemplates the value of rendition upgrades relative to all rendition upgrades such that some rendition upgrades may be kept based on the rendition upgrade value. As such, it is possible that a lower bitrate has more storage utility per byte than a higher bitrate, but the higher bitrate is kept, and the lower bit rate is evicted in view of the totality of the content considered. In turn, the present disclosure may not just keep the rendition with the highest storage utility per byte and evict the rest. It is possible that upgrading a given title-format pair to a higher bitrate may be a better use of disk space than storing a different low-probability title.

In turn, the incremental storage utility and the incremental size of a rendition upgrade may be determined, as discussed above in relation to FIGS. 9 and 10 to determine rendition upgrade values. Examples of these rendition upgrade values for the present example are shown in FIG. 20. A rendition upgrade listing 2000 is shown in which each respective upgrade of the rendition of the media object are identified (e.g., as a 0 to 1 nomenclature for a 0 GB/hr to a 1 GB/hr bitrate upgrade). In addition, the method 1000 of FIG. 10 may allow for collapsing rendition upgrades. A less sophisticated analysis may be to sort the rendition (e.g., bitrate) upgrades by storage utility per size and keep upgrades from the top of the list. However, scenarios may be considered such as if it is decided to keep the XA 0 to 1 upgrade at a size cost of 2 GB and XA 2 to 4 at a storage cost of 4 GB but evict XA 1 to 2 at a storage cost of 2 GB. This proposed scenario is disadvantageous because if XA-4 is kept, the rendition upgrade for XA from 0 to 4 would be kept, accounting for a storage cost of 8 GB of XA-4. One may expect diminishing returns as the bitrate of a given title-format pair is increased. For example, as bit rate increases, the rendition upgrade value decreases. This is illustrated in the case of WA. However, to consider cases like XA, it may be advantageous to collapse the rendition upgrades. This concept may be considered with the example of whether it is worth keeping something that has a rendition upgrade value of 1.0 cost units/GB; it is also worth keeping the XA 0 to 1 upgrade having the same rendition upgrade value. Further, if it is worth keeping something that's 0.9 cost units/GB, it may also be worth keeping the XA 1 to 4 upgrade.

Because the XA 1 to 2 upgrade has less of a rendition upgrade value than the XA 2 to 4 upgrade, it would not be advantageous to keep just the XA 1 to 2 upgrade and not the XA 2 to 4 upgrade. Because it may not be possible to keep the XA 2 to 4 upgrade without the XA 1 to 2 upgrade (because the XA 2 to 4 is a higher bitrate), one may consider these upgrades together as a single rendition upgrade unit. As such, the rendition upgrade value of the single rendition upgrade unit (which is considered in the method 1000 of FIG. 10 in operation 1010 as each available rendition upgrade is evaluated relative to the downgrade option) may be considered to calculate the rendition upgrade value of the combined upgrade - which turns out to be 0.9 cost units/GB. As can be seen, 0.9 cost units/GB is less than the rendition upgrade value of the XA 0 to 1 upgrade. As such, the process may be complete. However, if it were greater, the process may be repeated to collapse XA 0 to 1 and XA 1 to 4 into XA 0 to 4.

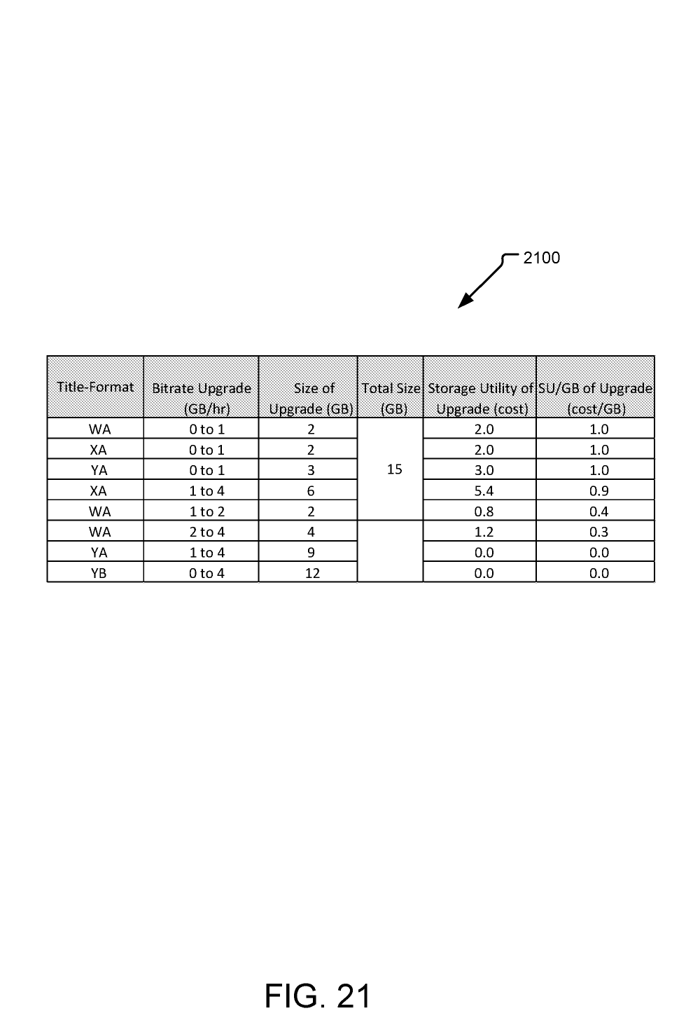

With further reference to FIG. 21, a rendition listing 2100 is shown in which the remaining upgrades (after collapsing the rendition upgrades as shown in FIG. 20) are provided in a sorted list by decreasing rendition upgrade values (represented as storage utility per size on disk or SU/GB). In particular, it may be that for any given title-format, the actual bitrate monotonically increases as the rendition upgrade value decreases due to the collapsing of the rendition upgrades.

As noted above, the example has 55 GB of stored content. The desired outcome is to evict 40 GB, leaving 15 GB remaining in the user cache. In turn, 15 GB of content is identified from the rendition listing 2100 as the 15 GB of content having the largest rendition upgrade values. In the illustrated example, this corresponds to the top five listed renditions in the rendition listing 2100 as shown with the “Total Size” column in the rendition listing 2100. In this regard, the eviction line or storage threshold for the analysis is provided at a rendition upgrade value of 0.4 cost units/GB as this is the rendition upgrade value for the last kept rendition upgrade of WA 1 to 2. In this example, 15 GB of content is maintained from the largest rendition upgrade values rather than evicting 40 GB of content from the lowest rendition upgrade values. This is because there are redundant copies of the same title-formats prior to the eviction. As such, evicting from the bottom would cause eviction of an unnecessarily large amount of content. Therefore, the eviction trigger may set a desired amount to keep rather than a desired amount to delete.

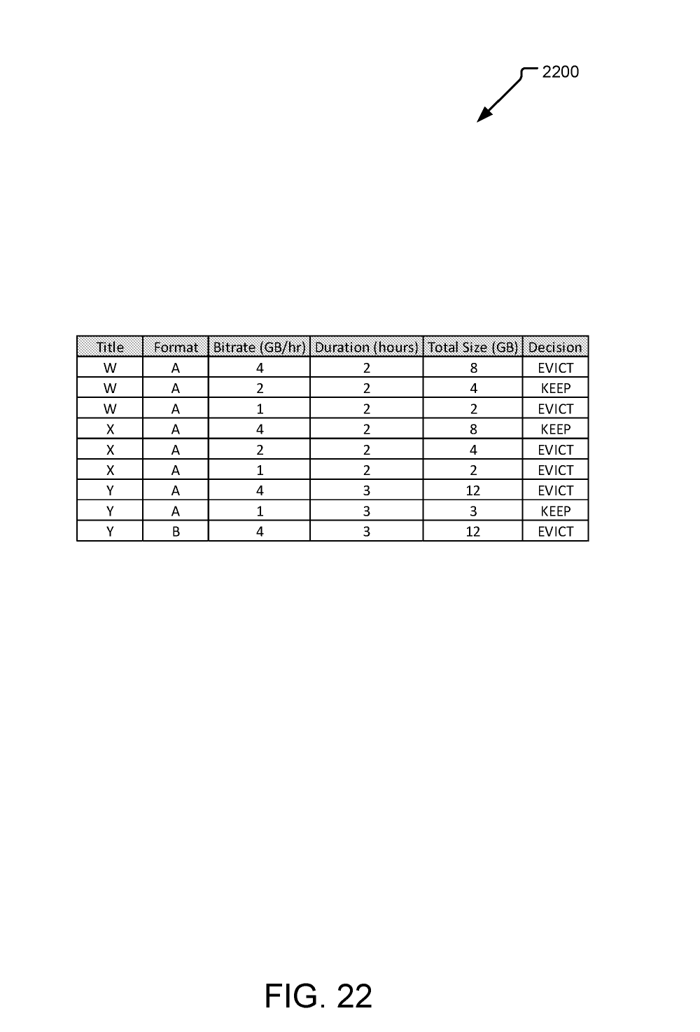

In turn, the original content 1700 from FIG. 17 is shown as revised content 2200 in FIG. 22 in which an evict/keep decision is supplemented in the revised content 2200. As can be appreciated from the revised content 2200, For WA, 0 to 1 and 1 to 2 rendition upgrades are kept. In other words, all rendition upgrades for WA-2 are kept. For XA, the 0 to 1 and 1 to 4 rendition upgrades are kept. As such, XA-4 is kept. For YA, the 0 to 1 rendition upgrade is kept, so YA-1 is stored. Note that all renditions for YB are evicted.

Reviewing the results demonstrates the effects of the storage eviction decision for the revised content 2200. The amount of content evicted is 8 + 2 + 4 + 2 + 12 + 12 = 40 GB of content, which satisfies the original eviction parameters. In addition, 4 + 8 + 3 = 15 GB of content is kept, also satisfying the original eviction parameters. Furthermore, at most one bitrate rendition is kept for any given title-format, thus avoiding duplicative renditions. In addition, a higher bitrate for XA is kept than for WA because the user is more likely to watch XA on a large screen than WA. As such, the practical ramifications of the evictions are logical given the potential user behaviors modeled.

Returning to the figures, FIG. 23 depicts an example of a method 2300 that may be used to provide an expected delivery action related to a model scenario as well as the delivery utility for the rendition of the expected delivery action. The method 2300 may include a receiving operation 2302 in which a request related to a media object is received. The request may provide information regarding a model scenario for the determination of which of a plurality of available renditions would be served to a user system given the model scenario. As discussed above, the model scenario may be defined by a given storage state of a user cache and a possible user behavior (e.g., related to the playback device that will be used to consume the media object.) In some cases, the “request” received at operation 2302 may be a hypothetical request, e.g., an identification of a rendition of a media object for processing by the method 2300 rather than a request for access to and/or delivery of the media object.

The method 2300 may also include an identifying operation 2304 in which a rendition of a requested media object is identified (e.g., from a manifest of a plurality of renditions for a media element of the media object). In this regard, a given one of the renditions may be identified such that a delivery utility of the rendition may be determined.

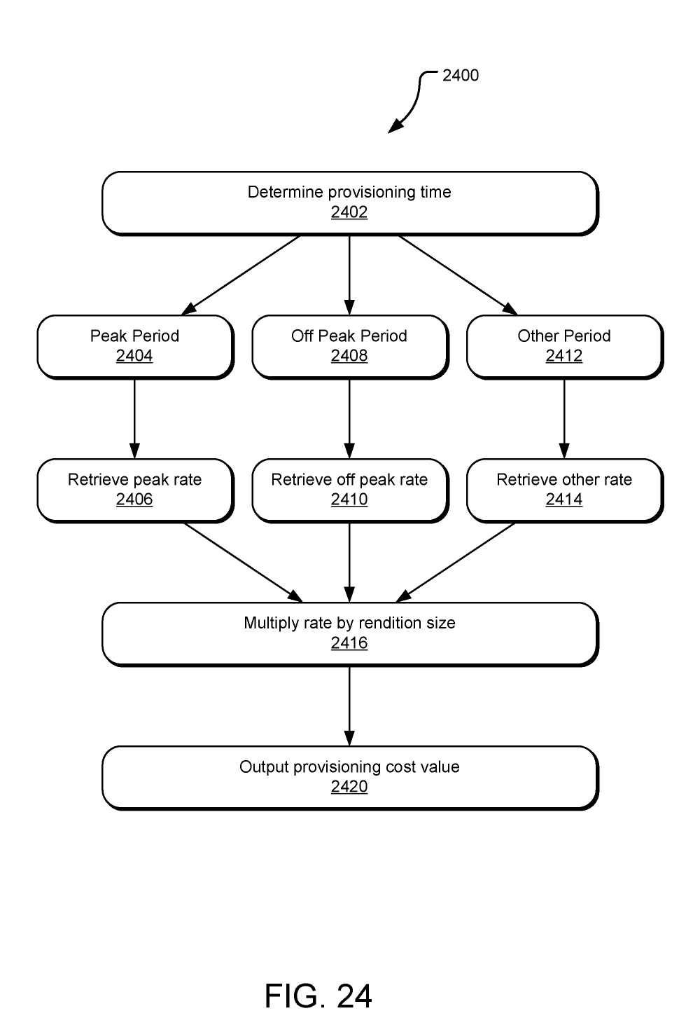

Specifically, determining the delivery utility may include a determining operation 2306 in which a provisioning cost value for the rendition is determined. Generally, the provisioning cost value represents a cost to the service provider to provide the specific rendition to a user terminal on the client side of the network. Details regarding determining the provisioning cost value for a rendition performed in the determining operation 2306 is described in greater detail below with respect to FIG. 24.

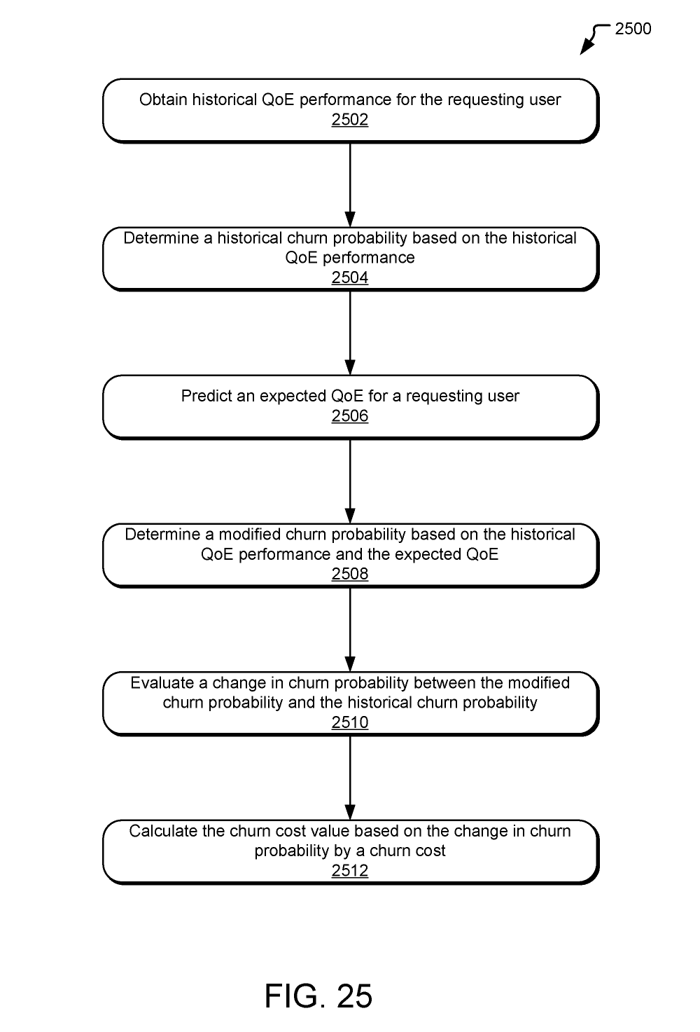

In addition, determining the delivery utility for the rendition may include a determining operation 2308 in which a churn cost value for the rendition is determined. The churn cost value represents a value associated with the change in the probability of user churn in the event of delivery of the rendition being considered. As may be appreciated, there may be costs associated with user churn, such as retrieval of equipment, loss of revenue, overhead associated with account management, or other costs. Additional details regarding determining the churn cost value performed in the determining operating 2308 for a rendition is described in greater detail below with respect to FIG. 25.

The method 2300 may include a combining operation 2310 in which the provisioning cost value determined in the determining operation 2306 and the churn cost value determined in the determining operation 2308 may be combined to provide a delivery utility for the rendition. A listing operation 2312 may be performed in which the rendition under consideration may be listed relative to the delivery utility of other renditions having been considered in the method 2300 for a model scenario.

As such, the method 2300 may include a logic block 2314 that determines if there are additional renditions available for the media object of the model scenario under consideration. If additional renditions are available, the method 2300 may iterate to the identifying operation 2304 in which another of the available renditions is identified and the process for determining the deliver utility may be repeated. In turn, the additional renditions may be added to the list of renditions in the listing operation 2312.

If the logical block 2314 determines that no additional renditions are available, the method 2300 may proceed to an identifying operation 2316 in which a selected rendition having a maximum delivery utility of all renditions in the list of renditions generated in the listing operation(s) 2312 may be identified for the model scenario. For a given model scenario, the selected rendition may represent an expected action that would be taken to fulfill a request made in the model scenario. In addition to the identification of the rendition to be served as the expected action, the delivery utility value for the selected rendition may be provided. As described in greater detail below, the delivery utilities related to a plurality of model scenarios may be used to populate a matrix for use in determining storage utilities for renditions. In other examples, rather than the iteration of the method 2300, logic may be used to identify a rendition to be delivered for the model scenario, and the method 2300 may be used in a single iteration (e.g., operations 2304-2310) to determine the delivery utility for the identified rendition.

While the method 2300 depicted in FIG. 23 provides one example for determining delivery utility, it may be appreciated that additional or fewer factors may be considered when determining delivery utility. That is, other factors in addition to a provisioning cost value and a churn cost value may be added to the determination of a delivery utility. As such, the example provided in FIG. 23 is not intended to be limiting as other considerations or values associated with the delivery utility may be determined and utilized in the selection of a given rendition to be served.

As noted above, in the determining operation 2306, a provisioning cost value is determined for a rendition. FIG. 24 depicts additional details regarding the determination of a provisioning cost value. Specifically, it is recognized that the provisioning cost value may differ based upon a time of day in which the media object would be served to the user or other factors such as network status at the time of request. That is, it is recognized that network resources may be valued differently based on factors including the congestion or likely congestion of the network. In this regard, certain times of day may exhibit greater network congestion and utilization than others. Such periods are often referred to as peak busy periods or peak periods. As such, other times of the day outside of a peak period may be referred to as off-peak time periods. Further still, other distinct periods may be identified in which the value for network utilization may differ from either peak or off-peak time periods. In this regard, specific rates for network utilization during different respective periods may be provided. The rates for the different periods may be empirically derived or may be utilized as tuning parameters that are selectively adjusted to elicit a desired behavior of the system.

Because the provisioning cost value may be time-dependent, a method 2400 for determining the provisioning cost value may include a determining operation 2402 in which the time at which the media object would be provided to the user terminal in the model scenario is determined. Accordingly, the method 2400 may proceed based on the time for the model scenario or based on other factors (e.g., network parameters) that are expected to exist at the time of the model scenario. As shown, a peak period 2404, an off-peak period 2408, and an other period 2412 may be provided. In this regard, the peak period 2404 and/or off-peak period 2408 may be defined relative to specific times of day. Furthermore, the other period 2412 may be associated with certain conditions that may be based on time of day, network utilization, or other network conditions (e.g., current network conditions) that may trigger the other period 2412.

Depending upon the determined period, different rates for a cost associated with provisioning may be retrieved. Specifically, if the peak period 2404 is determined, a peak rate 2406 may be retrieved. If an off-peak period 2408 is determined, an off-peak rate may be retrieved 2410. Additionally, if the other period 2412 is determined, an other rate 2414 may be retrieved. The rates may be provided as a cost per gigabyte figure. As such, the peak rate 2406 may be generally greater than the off-peak rate 2410, understanding that network resources may be more scarce or valuable during the peak period 2404. As such, increasing the rate for a given period may result in the system being more conservative regarding bandwidth usage. In addition, while three periods are depicted in the method 2400 of FIG. 24, it may be appreciated that any number of periods having any relative conditions may be provided with specific rates that may be provided for each period.

The method 2400 may further include a multiplying operation 2416 in which the retrieved rate may be multiplied by a size of the rendition that would be delivered via the shared forward link in the model scenario to determine the provisioning cost value for the rendition. As may be appreciated, the larger the amount of data required to be transmitted for a rendition (e.g., the network bandwidth required to provide the rendition to the requesting user), the larger the provisioning cost value for the rendition. As such, renditions that are fully or partially stored at the user content cache may require no additional data or an amount of data that is less than the total size of the rendition of the media object to be transferred using the shared forward link. In this regard, fully or partially cached renditions of a media object may be preferred over renditions that require network utilization to transmit because cached renditions may have a reduced provisioning cost.

The method 2400 may include an outputting operation 2420 in which the provision cost value determined by the multiplication performed in the multiply operation 2416 is output. In this regard, the provision cost value may be returned in the determining operation 2306 of FIG. 23 to be utilized in determining the deliver utility for the rendition. As may be appreciated, because the process depicted in FIG. 23 may be iterative for each available rendition, the method 2400 shown in FIG. 24 may be repeated for each given rendition to be considered.

FIG. 25 depicts a method 2500 for determining a churn cost value, which may be performed in the determining operation 2308 of FIG. 23. As generally described above, the churn cost value may represent a value associated with a change in probability of user churn in view of providing a rendition in a given model scenario. Specifically, the churn cost value may be related to the probability of providing a quality of experience to a user based on the rendition under consideration, the probability of churn in view of the quality of experience expected for the delivery of the rendition, and a value of churn for the given network. Each of these concepts is described in greater detail regarding the steps of the method 2500 below.

The churn cost value may be determined in view of a change in the probability of churn for delivering a rendition under consideration. As the churn cost value represents a change in probability, historical quality of experience performance may be retrieved for the user terminal for which the model scenarios relate to determine a historical churn probability. As may be appreciated in the following discussion, the churn cost value may be generally based on a total number of media object requests for a given user. That is, a churn probability for users having fewer requests in a churn period may more greatly impact the churn cost value in the event of a bad quality of experience. In contrast, a churn probability for users that have many requests in a churn period may not be as greatly affected by a single bad quality of experience for a requested media object.

In any regard, the method 2500 may include an obtaining operation 2502 in which historical quality of experience performance for a requesting user is retrieved. The obtaining operation 2502 may include obtaining actual historical performance for a quality of experience at the requesting user (e.g., from a use monitor 516 as described above).

The quality of experience performance may be based on quality of experience performance indicators. Specifically, the performance of prior served media objects at a user terminal relative to the quality of experience performance indicators may dictate the historical quality of experience performance. The historical quality of experience performance for the requesting user may be determined within a churn period. The churn period may comprise a window of time over which the quality of experience performance of prior deliveries affects the probability of user churn. That is, the churn period may be tied to a length of time that a given quality of experience affects a user's likelihood to churn. As such, the churn period may be tied to a billing cycle (e.g., typically a 30-day period) or may be empirically derived based on a determination of the length of time the quality of experience for a media object delivery affects a user's churn probability.

The method 2500 may further include a determining operation 2504 in which a historical churn probability for the user terminal of the model scenario is determined based on the historical quality of experience performance. The historical churn probability may be algorithmically derived using an algorithm taking as an input the historical quality of experience performance for the user terminal. In other examples, the historical churn probability may be determined based on a predictive model trained using actual user behavior data relative to quality of experience performance. In this regard, training data comprising information on user churn instances paired with corresponding historical quality of experience performance data associated with the user churn instances may be used to train a machine learning model. In turn, historical quality of experience performance data from the obtaining operation 2502 may be input into the machine learning model to determine the historical churn probability in the determining operation 2504.

Further still, whether determined by an algorithmic approach or a machine learning model approach, the historical churn probability for a given user terminal may also consider non-quality of experience-related factors such as user demographics, receipt of free content, or other factors that may be determined to affect user churn probability outside of quality of experience-related factors. Such non-quality of experience-related factors may include the probability of relocation of users outside of a service area or other non-performance-related factors that may contribute to churn. Further still, historical churn probability may be determined at a discrete time, such as a time of a model scenario. In some examples, the model scenarios for determination of storage utility may contemplate a plurality of times such that one dimension of the matrix may be time such that different time periods may be determined for different ones of the model scenarios.

The method 2500 may further include a predicting operation 2506. The predicting operation 2506 may be used to predict an expected quality of experience for a requesting user being served a rendition under consideration. The quality of experience may be characterized relative to one or more quality of experience categories. In one example, the quality of experience categories may be binary, with a good category and a bad category defining the possible quality of experience outcomes. In other approaches, other quality of experience categories may be provided to characterize possible quality of experience outcomes such as a low quality of experience, a medium quality of experience, and a high quality experience. Further still, the expected quality of experience may be provided as a continuous value over a given range such as from 0 to 1 or from 0 to 100.

Regardless of the number of quality of experience categories provided, the respective quality of experience categories may be defined relative to quality of experience performance indicators. That is, the expected quality of experience for a requesting user being served a rendition under consideration may be determined based on how the rendition is expected to perform relative to the one or more quality of experience performance indicators. Examples of quality of experience performance indicators include, but are not limited to, whether a media object start failure occurs, whether a media object playback failure occurs, whether a user exits before playback start after a threshold start time, whether a media object begins playback within a threshold playback time, a minimum fidelity based on a user screen associated with the request, etc.

In addition, the quality of experience performance indicators may be combined in different ways to determine an expected quality of experience. For example, certain quality of experience performance indicators may be more heavily weighted than others when determining the expected quality of experience for a rendition. The manner in which the quality of experience performance indicators are combined to provide an expected quality of experience for a requesting user may be based on modeled behavior, which may be provided as a machine learning model trained from a store of historical performance data. In other examples, the manner in which quality of experience performance indicators are combined to provide an expected quality of experience may be based on externally derived information such as user survey data or the like.

Furthermore, a quality of experience performance indicator may relate to the characteristics of a given media object requested. Such characteristics of the media object may be provided as metadata of the requested media object. For example, a quality experience performance indicator may be based on the genre of the requested media object. In one example, an action movie may benefit from a higher quality of video than if the media object requested is a cartoon. As such, the quality of experience performance indicators may vary based on metadata for the media object, such as the genre of the media object.

In any regard, the expected quality of experience for a given rendition may be determined in view of the quality of experience performance indicators. As noted above, the expected quality of experience may be determined using a machine learning model. Such a machine learning model may be trained using historical quality of experience performance data regarding previously served renditions, network characteristics, actual delivery quality, or other information. That is, the model may provide an expected performance of a rendition relative to the quality of experience performance indicators to determine the expected quality of experience for the rendition under consideration.

In other examples, the expected quality experience for the rendition may be based on objective measures such as a minimum fidelity per screen size value. This objective measure may be determined based on information regarding a playback device of the requesting user. Furthermore, an expected quality of experience may be at least in part based on whether the rendition is to be served from the provider side of the network (e.g., from the provider media module) or if the rendition is available in the user content cache at the client side. As may be appreciated, an expected quality of experience may be more likely categorized as a good quality of experience if the rendition is available in the user content cache because variables regarding network performance for delivery of the rendition may not affect the provision of the rendition to the user.

Furthermore, a model for providing an expected quality experience for a rendition may also factor an amount of a given rendition contained in the client content cache. For example, the expected quality experience for a rendition that is entirely stored in the client content cache may be different than for a rendition for which only a portion (e.g., 25%, 50%, 75%) of the rendition is stored in the client content cache. That is, the model scenario may be that a portion of the rendition may be required to be delivered over the shared forward communication link, which may be subject to hard-to-predict variables that affect the expected quality of experience for the rendition.

The method 2500 may further include a determining operation 2508 in which a modified churn probability is determined. The modified churn probability may be based on the historical quality of experience performance and the expected quality of experience determined in the method 2500. That is, the modified churn probability may be determined using the same algorithmic approach or machine learning model described above, which is used to determine the historical term probability. That is, the modified churn probability may represent a change in churn probability considering an expected quality of experience for a rendition in combination with the historical churn probability.

In one example, the expected quality of experience may be a probability distribution of a rendition achieving each of the quality of experience categories. Using the example of a binary (e.g., good/bad) quality of experience category structure, an expected quality of experience may include a probability distribution of the rendition achieving a good quality experience and a bad quality of experience. As such, the probability distribution may represent the respective probabilities of the rendition achieving each of the quality of experience categories. As such, the modified churn probability determined in the determining operation 2508 may represent a change in the probability of the user churning based on the expected quality of experience provided by the rendition being considered. In this regard, the change in churn probability may be a weighted combination over the probability distribution of each quality of experience category. That is, the more likely the rendition achieves a given quality of experience category, the more heavily that quality of experience category probability may influence the change in churn probability. The method 2500 may include an evaluating operation 2510 in which the change in churn probability between the modified churn probability (e.g., as determined based on historical quality of experience performance data and the probability distribution of achieving an expected quality of experience) is determined.

The method 2500 may further include calculating the churn cost value in a calculating operation 2512, which may be based on the change in churn probability between the modified churn probability and the historical churn probability and a churn cost. A churn cost may be empirically derived based on cost measures associated with user churn. In other examples, the churn cost may be a tunable parameter that is selectable for the system to elicit specific system behavior. In any regard, in one example, the churn cost value may be determined by combining (e.g., multiplying) the churn cost with the change in churn probability. This achieves a churn cost value representative of the effect on churn cost associated with serving the rendition under consideration. The calculating operation 2512 may provide a safeguard for a minimum quality to be delivered to the requesting user. This may prevent the system from determining that it is best not to serve the user any rendition of the media object in response to the request.

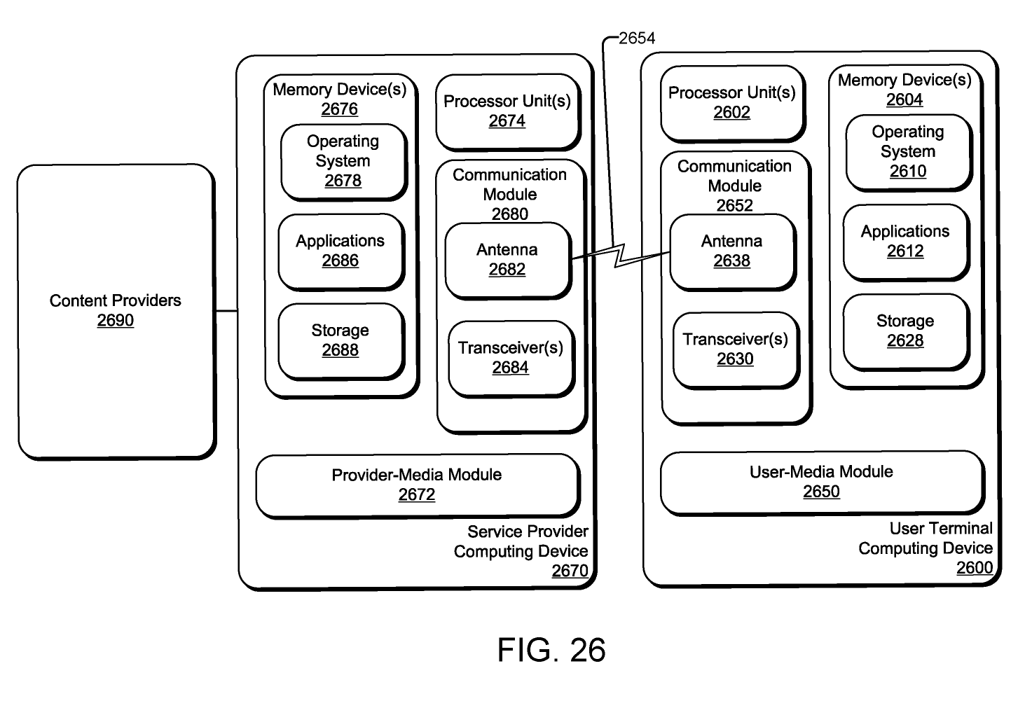

FIG. 26 illustrates an example schematic of a user terminal computing device 2600 suitable for implementing aspects of the disclosed technology. The user terminal computing device 2600 generally executes a user-media module 2650 in connection with the foregoing description. The user terminal computing device 2600 includes one or more processor unit(s) 2602 and memory 2604. The memory 2604 generally includes both volatile memory (e.g., RAM) and non-volatile memory (e.g., flash memory). An operating system 2610, such as the Microsoft Windows® operating system, the Apple macOS operating system, the Linux operating system, or the like resides in the memory 2604 and is executed by the processor unit(s) 2602. The memory 2604 may also include machine readable instructions that are executable by the one or more processor unit(s) 2602 to execute functionality of the user-media module 2650.

The user terminal computing device 2600 may also include a communication module 2652. The communication module 2652 may include any appropriate hardware, software, and firmware to enable communication via respective communication channels 2654 with a service provider computing device 2670. For example, the communication module 2652 may include a router (not shown), modem (not shown), transceiver 2630, antenna 2638 or other equipment to facilitate communication by the communication module 2652.

One or more applications 2612 may be loaded in the memory 2604 and executed on the operating system 2610 by the processor unit(s) 2602 to provide functionality of the user-media module 2650 in a manner described above. Applications 2612 may receive input from various input local devices such as a keypad, mouse, stylus, touchpad, joystick, an instrument-mounted input, or the like. The user terminal computing device 2600 may also include various other components, such as a positioning system (e.g., a global positioning satellite transceiver) and storage devices 2628. Other configurations may also be employed.

In an example implementation, the user terminal computing device 2600 comprises hardware and/or software embodied by instructions stored in the memory 2604 and/or the storage devices 2628 and processed by the processor unit(s) 2602. The memory 2604 may be the memory of a host device or of an accessory that couples to the host. Additionally or alternatively, the user terminal computing device 2600 may comprise one or more field programmable gate arrays (FPGAs), application-specific integrated circuits (ASIC), or other hardware/software/firmware capable of providing the functionality described herein.

As noted above, the user terminal computing device 2600 may be in communication with a service provider computing device 2670 via the shared communication channel 2654. The service provider computing device generally executes a provider-media module 2672 in connection with the foregoing description. The service provider computing device 2670 includes one or more processor unit(s) 2674 and memory 2676. The memory 2676 generally includes both volatile memory (e.g., RAM) and non-volatile memory (e.g., flash memory). An operating system 2678, such as the Microsoft Windows® operating system, the Apple macOS operating system, the Linux operating system, or the like resides in the memory 2676 and is executed by the processor unit(s) 2674.

The service provider computing device 2670 may also include a communication module 2680. The communication module 2680 may include any appropriate hardware, software, and firmware to enable communication via the shared forward communication link 2654 with the user terminal computing device 2600. For example, the communication module 2652 may include a router (not shown), modem (not shown), transceiver 2684, antenna 2682 or other equipment to facilitate communication by the communication module 2680.

One or more applications 2686 may be loaded in the memory 2676 and executed on the operating system 2678 by the processor unit(s) 2674 to provide functionality of the provider-media module 2672 in a manner described above. Applications 2686 may receive input from various input local devices such as a keypad, mouse, stylus, touchpad, joystick, an instrument-mounted input, or the like. The service provider computing device 2670 may also include various other components, such as a positioning system (e.g., a global positioning satellite transceiver) and storage devices 2688. Other configurations may also be employed.

In an example implementation, the service provider computing device 2670 comprises hardware and/or software embodied by instructions stored in the memory 2676 and/or the storage devices 2688 and processed by the processor unit(s) 2674. The memory 2676 may be the memory of a host device or of an accessory that couples to the host. Additionally, or alternatively, the service provider computing device 2670 may comprise one or more field programmable gate arrays (FPGAs), application-specific integrated circuits (ASIC), or other hardware/software/firmware capable of providing the functionality described herein. In other examples, the service provider computing device 2670 and/or the provider-media module 2672 may be executed as a cloud computing instance such that the service provider computing device 2670 may comprise virtualized resources provided via cloud computing architecture.

The service provider computing device 2670 may be in further communication with one or more content providers 2690. The service provider computing device 2670 may access the one or more content providers 2690 via a network or local connection to access content data and/or receive a manifest according to the foregoing disclosure.

The user terminal computing device 2600 and/or service provider computing device 2670 may include a variety of tangible processor-readable storage media and intangible processor-readable communication signals. Tangible processor-readable storage can be embodied by any available media that can be accessed by the user terminal computing device 2600 and service provider computing device 2670 and includes both volatile and non-volatile storage media, removable and non-removable storage media. Tangible processor-readable storage media excludes intangible communications signals and includes volatile, non-volatile, removable, and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the user terminal computing device 2600. In contrast to tangible processor-readable storage media, intangible processor-readable communication signals may embody processor-readable instructions, data structures, program modules, or other data resident in a modulated data signal, such as a carrier wave or other signal transport mechanism. The term "modulated data signal" means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

In some aspects, the techniques described herein relate to a method for performing storage decisions for a content cache, including: identifying one or more renditions of at least one media element of one or more media objects; determining a storage utility for the one or more renditions; calculating a rendition upgrade value for available rendition upgrades, wherein the rendition upgrade value is based on an incremental storage utility of a rendition upgrade and an incremental storage size of the rendition upgrade; sorting a listing of one or more available rendition upgrades by the rendition upgrade value; and electing not to store all renditions associated with the one or more available rendition upgrades that fail to meet a minimum rendition upgrade threshold.

In some aspects, the techniques described herein relate to a method, wherein the determining the storage utility for a rendition is based on a delivery utility of an expected delivery action in response to possible user behaviors for requesting a media object to which the rendition relates.

In some aspects, the techniques described herein relate to a method, wherein the expected delivery action is based on a storage state of the rendition in the content cache.

In some aspects, the techniques described herein relate to a method, wherein the possible user behaviors are associated with a behavior probability of a user behavior occurring.

In some aspects, the techniques described herein relate to a method, wherein the possible user behaviors are associated with probabilities of a user of a household viewing the media object on different screen sizes.

In some aspects, the techniques described herein relate to a method, wherein the determining the storage utility for the one or more renditions includes: modeling a plurality of possible user behaviors for requesting the media object to which the one or more renditions relate; determining a behavior probability for each of the plurality of possible user behaviors; calculating the delivery utility for a delivered rendition in the expected delivery action in a plurality of model scenarios, the plurality of model scenarios each including a unique combination of the plurality of possible user behaviors and a plurality of potential storage states of the one or more renditions in the content cache; and multiplying the delivery utility for the expected rendition delivered in each of the plurality of model scenarios by a corresponding user behavior probability of the model scenario to determine the storage utility for the rendition of the expected delivered rendition.

In some aspects, the techniques described herein relate to a method, wherein the behavior probability for each of the plurality of possible user behaviors is relative to a future period of interest.

In some aspects, the techniques described herein relate to a method, wherein the future period of interest is relative to an expected surplus resources of a shared forward communication link.

In some aspects, the techniques described herein relate to a method, wherein the future period of interest is 24 hours.

In some aspects, the techniques described herein relate to a method, wherein the behavior probability is based on prior media object consumption at a user terminal including the content cache.

In some aspects, the techniques described herein relate to a method, wherein the behavior probability is based on a user behavior prediction model.

In some aspects, the techniques described herein relate to a method, wherein the user behavior prediction model includes a supervised machine learning model trained with labeled training data that relates observed historical user behavior with feature vectors including predictor variables for media objects consumed in the observed historical user behavior.

In some aspects, the techniques described herein relate to a method, wherein the user behavior prediction model is applied to the plurality of possible user behaviors to generate the user behavior probability for each of the plurality of possible user behaviors.

In some aspects, the techniques described herein relate to a method, wherein the user behavior prediction model receives as input a feature vector for the media object including predictor variables corresponding to the predictor variables of the labeled training data.

In some aspects, the techniques described herein relate to a method, wherein the predictor variables include at least one of user affinity, cast affinity, and genre affinity.

In some aspects, the techniques described herein relate to a method, wherein the predictor variables are based on metadata for the media object.

In some aspects, the techniques described herein relate to a method, wherein the predictor variables are based on whether the media object includes episodic content or unitary content.

In some aspects, the techniques described herein relate to a method, wherein the predictor variables are based on whether the media object is associated with prior user engagement.

In some aspects, the techniques described herein relate to a method, further including: cataloging contents of the content cache including the one or more renditions; and evicting the renditions stored in the content cache that are associated with the available rendition upgrades that fail to meet the minimum rendition upgrade threshold.

In some aspects, the techniques described herein relate to a method, wherein at least one rendition of the one or more renditions is received at a user terminal via a forward communication link, and wherein the at least one rendition is stored in the content cache if the rendition upgrade value for the at least one rendition meets the minimum rendition upgrade threshold and is not stored in the content cache if the rendition upgrade value for the at least one rendition fails to meet the minimum rendition upgrade threshold.

In some aspects, the techniques described herein relate to a method, further including: detecting an eviction trigger, wherein the method is performed in response to detection of the eviction trigger.

In some aspects, the techniques described herein relate to a method, wherein the eviction trigger includes a used storage capacity of the content cache satisfying a storage threshold.

In some aspects, the techniques described herein relate to a method, wherein the eviction trigger includes a periodic temporal trigger.

In some aspects, the techniques described herein relate to a method, further including: establishing the minimum rendition upgrade threshold based on an identified amount of storage space to be made available.

In some aspects, the techniques described herein relate to a method, wherein the minimum rendition upgrade threshold is a defined value.

In some aspects, the techniques described herein relate to a method, wherein the calculating the rendition upgrade value for a rendition upgrade includes: for a rendition of the one or more renditions, determining a downgrade option relative to the rendition, wherein the rendition relative to the downgrade option includes the rendition upgrade; subtracting a downgrade storage utility for the downgrade option from a storage utility of the rendition to calculate the rendition upgrade value for the rendition upgrade; subtracting a downgrade content size of the downgrade option from a content size of the rendition to calculate the incremental storage size of the rendition upgrade; and dividing the incremental storage utility of the rendition upgrade by the incremental storage size of the rendition upgrade to calculate the rendition upgrade value.

In some aspects, the techniques described herein relate to a method, further including: iterating the calculating by setting the rendition as the downgrade option relative to a higher-resource rendition for a media object.

In some aspects, the techniques described herein relate to a method, wherein the iterating is performed until all renditions of the one or more renditions have been evaluated as the rendition upgrade relative to the downgrade option.

In some aspects, the techniques described herein relate to a method, wherein the downgrade option includes a null rendition corresponding to no storage of any rendition for a media object.

In some aspects, the techniques described herein relate to a method, further including: finding a selected rendition with a maximum rendition upgrade value relative to the downgrade rendition option; and adding the selected rendition to the listing.

In some aspects, the techniques described herein relate to a system for performing storage decisions for a content cache, including: a content cache including a memory store for storage of media content objects; and a storage manager in operative communication with the content cache and operative to: identify one or more renditions for one or more media elements of one or more media objects; determine a storage utility for the one or more renditions; calculate a rendition upgrade value for available rendition upgrades, wherein the rendition upgrade value is based on an incremental storage utility of a rendition upgrade and an incremental storage size of the rendition upgrade; sort a listing of one or more available rendition upgrades by the rendition upgrade value; and elect not to store all renditions associated with the one or more available rendition upgrades that fail to meet a minimum rendition upgrade threshold.

In some aspects, the techniques described herein relate to a system, wherein the storage manager is further operative to: determine the storage utility for a rendition is based on a delivery utility of an expected delivery action in response to possible user behaviors for requesting a media object to which the rendition relates.

In some aspects, the techniques described herein relate to a system, wherein the expected delivery action is based on a storage state of the rendition in the content cache.

In some aspects, the techniques described herein relate to a system, wherein the possible user behaviors are associated with a behavior probability of a user behavior occurring.

In some aspects, the techniques described herein relate to a system, wherein the possible user behaviors are associated with probabilities of a user of a household viewing the media object on different screen sizes.

In some aspects, the techniques described herein relate to a system, wherein the storage manager determines the storage utility for the one or more renditions by: modeling a plurality of possible user behaviors for requesting the media object to which the one or more renditions relate; determining a behavior probability for each of the plurality of possible user behaviors; calculating the delivery utility for a delivered rendition in the expected delivery action in a plurality of model scenarios, the plurality of model scenarios each including a unique combination of the plurality of possible user behaviors and a plurality of potential storage states of the one or more renditions in the content cache; and multiplying the delivery utility for the expected rendition delivered in each of the plurality of model scenarios by a corresponding user behavior probability of the model scenario to determine the storage utility for the rendition of the expected delivered rendition.

In some aspects, the techniques described herein relate to a system, wherein the behavior probability for each of the plurality of possible user behaviors is relative to a future period of interest.

In some aspects, the techniques described herein relate to a system, wherein the future period of interest is relative to expected surplus resources of a forward communication.

In some aspects, the techniques described herein relate to a system, wherein the future period of interest is 24 hours.

In some aspects, the techniques described herein relate to a system, wherein the behavior probability is based on prior media object consumption at a user terminal including the content cache.

In some aspects, the techniques described herein relate to a system, further including: a user behavior prediction model, wherein the behavior probability is based on the user behavior prediction model.

In some aspects, the techniques described herein relate to a system, wherein the user behavior prediction model includes a supervised machine learning model trained with labeled training data that relates observed historical user behavior to feature vectors including predictor variables for media objects consumed in the observed historical user behavior.

In some aspects, the techniques described herein relate to a system, wherein the user behavior prediction model is applied to the plurality of possible user behaviors to generate the user behavior probability for each of the plurality of possible user behaviors.

In some aspects, the techniques described herein relate to a system, wherein the user behavior prediction model receives as input a feature vector for the media object including predictor variables corresponding to the predictor variables of the labeled training data.

In some aspects, the techniques described herein relate to a system, wherein the predictor variables include at least one of user affinity, cast affinity, and genre affinity.

In some aspects, the techniques described herein relate to a system, wherein the predictor variables are based on metadata for the media object.

In some aspects, the techniques described herein relate to a system, wherein the predictor variables are based on whether the media object includes episodic content or unitary content.

In some aspects, the techniques described herein relate to a system, wherein the predictor variables are based on whether the media object is associated with prior user engagement.

In some aspects, the techniques described herein relate to a system, further including: a user terminal including the content cache; wherein the one or more renditions are stored in the content cache and the storage manager evicts the renditions stored in the content cache that are associated with the available rendition upgrades that fail to meet the minimum rendition upgrade threshold.

In some aspects, the techniques described herein relate to a system, further including: a communication interface at a user terminal including the content cache; wherein at least one rendition of the one or more renditions is received at the communication interface via a forward communication link, and wherein the storage manager stores the at least one rendition in the content cache if the rendition upgrade value for the at least one rendition meets the minimum rendition upgrade threshold and the storage manager does not store the at least one rendition in the content cache if the rendition upgrade value for the at least one rendition fails to meet the minimum rendition upgrade threshold.

In some aspects, the techniques described herein relate to a system, wherein the storage manager is further operative to: detect an eviction trigger, wherein the storage manager performs content eviction in response to detection of the eviction trigger.

In some aspects, the techniques described herein relate to a system, wherein the eviction trigger includes a used storage capacity of the content cache satisfying a storage threshold.

In some aspects, the techniques described herein relate to a system, wherein the eviction trigger includes a periodic temporal trigger.

In some aspects, the techniques described herein relate to a system, wherein the storage manager is further operative to: establish the minimum rendition upgrade threshold based on an identified amount of storage space to be made available.

In some aspects, the techniques described herein relate to a system, wherein the minimum rendition upgrade threshold is a defined value.

In some aspects, the techniques described herein relate to a system, wherein the storage manager is operative to calculate the rendition upgrade value for a rendition upgrade by: for a rendition of the one or more renditions, determining a downgrade option relative to the rendition, wherein the rendition relative to the downgrade option includes the rendition upgrade; subtracting a downgrade storage utility for the downgrade option from a storage utility of the rendition to calculate the rendition upgrade value for the rendition upgrade; subtracting a downgrade content size of the downgrade option from a content size of the rendition to calculate the incremental storage size of the rendition upgrade; and dividing the incremental storage utility of the rendition upgrade by the incremental storage size of the rendition upgrade to calculate the rendition upgrade value.

In some aspects, the techniques described herein relate to a system, wherein the storage manager is further operative to: iterate the calculation of the by setting the rendition as the downgrade option relative to a higher-resource rendition for a media object.

In some aspects, the techniques described herein relate to a system, wherein the iteration is performed until all renditions of the one or more renditions have been evaluated as the rendition upgrade relative to the downgrade option.

In some aspects, the techniques described herein relate to a system, wherein the downgrade option includes a null rendition corresponding to no storage of any rendition for a media object.

In some aspects, the techniques described herein relate to a system, wherein the storage manager is further operative to: find a selected rendition with a maximum rendition upgrade value relative to the downgrade rendition option; and add the selected rendition to the listing.

In some aspects, the techniques described herein relate to a system, further including: a user terminal including the content cache; wherein the storage manager is located at the user terminal.

In some aspects, the techniques described herein relate to a system, further including: a user terminal including the content cache; wherein the storage manager is located remote from the user terminal.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for performing storage decisions for a content cache, comprising:
identifying one or more renditions of at least one media element of one or more media objects;
determining a storage utility for the one or more renditions;
calculating a rendition upgrade value for available rendition upgrades, wherein the rendition upgrade value is based on an incremental storage utility of a rendition upgrade and an incremental storage size of the rendition upgrade;
sorting a listing of one or more available rendition upgrades by the rendition upgrade value; and
electing not to store all renditions associated with the one or more available rendition upgrades that fail to meet a minimum rendition upgrade threshold.

2. The method of claim 1, wherein the determining the storage utility for a rendition is based on a delivery utility of an expected delivery action in response to possible user behaviors for requesting a media object to which the rendition relates.

3. The method of claim 2, wherein the expected delivery action is based on a storage state of the rendition in the content cache.

4. The method of claim 3, wherein the possible user behaviors are associated with a behavior probability of a user behavior occurring.

5. The method of claim 4, wherein the possible user behaviors are associated with probabilities of a user of a household viewing the media object on different screen sizes.

6. The method of claim 2, wherein the determining the storage utility for the one or more renditions comprises:
modeling a plurality of possible user behaviors for requesting the media object to which the one or more renditions relate;
determining a behavior probability for each of the plurality of possible user behaviors;
calculating the delivery utility for a delivered rendition in the expected delivery action in a plurality of model scenarios, the plurality of model scenarios each comprising a unique combination of the plurality of possible user behaviors and a plurality of potential storage states of the one or more renditions in the content cache; and
multiplying the delivery utility for the expected rendition delivered in each of the plurality of model scenarios by a corresponding user behavior probability of the model scenario to determine the storage utility for the rendition of the expected delivered rendition.

7. The method of claim 6, wherein the behavior probability for each of the plurality of possible user behaviors is relative to a future period of interest.

8. The method of claim 7, wherein the future period of interest is relative to an expected surplus resources of a shared forward communication link.

9. The method of claim 8, wherein the future period of interest is 24 hours.

10. The method of claim 6, wherein the behavior probability is based on prior media object consumption at a user terminal comprising the content cache.

11. The method of claim 10, wherein the behavior probability is based on a user behavior prediction model.

12. The method of claim 11, wherein the user behavior prediction model comprises a supervised machine learning model trained with labeled training data that relates observed historical user behavior with feature vectors comprising predictor variables for media objects consumed in the observed historical user behavior.

13. The method of claim 12, wherein the user behavior prediction model is applied to the plurality of possible user behaviors to generate the user behavior probability for each of the plurality of possible user behaviors.

14. The method of claim 13, wherein the user behavior prediction model receives as input a feature vector for the media object comprising predictor variables corresponding to the predictor variables of the labeled training data.

15. The method of claim 14, wherein the predictor variables comprise at least one of user affinity, cast affinity, and genre affinity.

16. The method of claim 14, wherein the predictor variables are based on metadata for the media object.

17. The method of claim 16, wherein the predictor variables are based on whether the media object comprises episodic content or unitary content.

18. The method of claim 16, wherein the predictor variables are based on whether the media object is associated with prior user engagement.

19. The method of claim 1, further comprising:
cataloging contents of the content cache comprising the one or more renditions; and
evicting the renditions stored in the content cache that are associated with the available rendition upgrades that fail to meet the minimum rendition upgrade threshold.

20. The method of claim 1, wherein at least one rendition of the one or more renditions is received at a user terminal via a forward communication link, and wherein the at least one rendition is stored in the content cache if the rendition upgrade value for the at least one rendition meets the minimum rendition upgrade threshold and is not stored in the content cache if the rendition upgrade value for the at least one rendition fails to meet the minimum rendition upgrade threshold.

21. The method of claim 1, further comprising:
detecting an eviction trigger, wherein the method is performed in response to detection of the eviction trigger.

22. The method of claim 21, wherein the eviction trigger comprises a used storage capacity of the content cache satisfying a storage threshold.

23. The method of claim 21, wherein the eviction trigger comprises a periodic temporal trigger.

24. The method of claim 1, further comprising:
establishing the minimum rendition upgrade threshold based on an identified amount of storage space to be made available.

25. The method of claim 1, wherein the minimum rendition upgrade threshold is a defined value.

26. The method of claim 1, wherein the calculating the rendition upgrade value for a rendition upgrade comprises:
for a rendition of the one or more renditions, determining a downgrade option relative to the rendition, wherein the rendition relative to the downgrade option comprises the rendition upgrade;
subtracting a downgrade storage utility for the downgrade option from a storage utility of the rendition to calculate the rendition upgrade value for the rendition upgrade;
subtracting a downgrade content size of the downgrade option from a content size of the rendition to calculate the incremental storage size of the rendition upgrade; and
dividing the incremental storage utility of the rendition upgrade by the incremental storage size of the rendition upgrade to calculate the rendition upgrade value.

27. The method of claim 26, further comprising:
iterating the calculating by setting the rendition as the downgrade option relative to a higher-resource rendition for a media object.

28. The method of claim 27, wherein the iterating is performed until all renditions of the one or more renditions have been evaluated as the rendition upgrade relative to the downgrade option.

29. The method of claim 26, wherein the downgrade option comprises a null rendition corresponding to no storage of any rendition for a media object.

30. The method of claim 26, further comprising:
finding a selected rendition with a maximum rendition upgrade value relative to the downgrade rendition option; and
adding the selected rendition to the listing.

31. A system for performing storage decisions for a content cache, comprising:
a content cache comprising a memory store for storage of media content objects; and
a storage manager in operative communication with the content cache and operative to:
identify one or more renditions for one or more media elements of one or more media objects;
determine a storage utility for the one or more renditions;
calculate a rendition upgrade value for available rendition upgrades, wherein the rendition upgrade value is based on an incremental storage utility of a rendition upgrade and an incremental storage size of the rendition upgrade;
sort a listing of one or more available rendition upgrades by the rendition upgrade value; and
elect not to store all renditions associated with the one or more available rendition upgrades that fail to meet a minimum rendition upgrade threshold.

32. The system of claim 31, wherein the storage manager is further operative to:
determine the storage utility for a rendition is based on a delivery utility of an expected delivery action in response to possible user behaviors for requesting a media object to which the rendition relates.

33. The system of claim 32, wherein the expected delivery action is based on a storage state of the rendition in the content cache.

34. The system of claim 33, wherein the possible user behaviors are associated with a behavior probability of a user behavior occurring.

35. The system of claim 34, wherein the possible user behaviors are associated with probabilities of a user of a household viewing the media object on different screen sizes.

36. The system of claim 32, wherein the storage manager determines the storage utility for the one or more renditions by:
modeling a plurality of possible user behaviors for requesting the media object to which the one or more renditions relate;
determining a behavior probability for each of the plurality of possible user behaviors;
calculating the delivery utility for a delivered rendition in the expected delivery action in a plurality of model scenarios, the plurality of model scenarios each comprising a unique combination of the plurality of possible user behaviors and a plurality of potential storage states of the one or more renditions in the content cache; and
multiplying the delivery utility for the expected rendition delivered in each of the plurality of model scenarios by a corresponding user behavior probability of the model scenario to determine the storage utility for the rendition of the expected delivered rendition.

37. The system of claim 36, wherein the behavior probability for each of the plurality of possible user behaviors is relative to a future period of interest.

38. The system of claim 37, wherein the future period of interest is relative to expected surplus resources of a forward communication.

39. The system of claim 38, wherein the future period of interest is 24 hours.

40. The system of claim 36, wherein the behavior probability is based on prior media object consumption at a user terminal comprising the content cache.

41. The system of claim 40, further comprising:
a user behavior prediction model, wherein the behavior probability is based on the user behavior prediction model.

42. The system of claim 41, wherein the user behavior prediction model comprises a supervised machine learning model trained with labeled training data that relates observed historical user behavior to feature vectors comprising predictor variables for media objects consumed in the observed historical user behavior.

43. The system of claim 42, wherein the user behavior prediction model is applied to the plurality of possible user behaviors to generate the user behavior probability for each of the plurality of possible user behaviors.

44. The system of claim 43, wherein the user behavior prediction model receives as input a feature vector for the media object comprising predictor variables corresponding to the predictor variables of the labeled training data.

45. The system of claim 44, wherein the predictor variables comprise at least one of user affinity, cast affinity, and genre affinity.

46. The system of claim 44, wherein the predictor variables are based on metadata for the media object.

47. The system of claim 46, wherein the predictor variables are based on whether the media object comprises episodic content or unitary content.

48. The system of claim 46, wherein the predictor variables are based on whether the media object is associated with prior user engagement.

49. The system of claim 31, further comprising:
a user terminal comprising the content cache;
wherein the one or more renditions are stored in the content cache and the storage manager evicts the renditions stored in the content cache that are associated with the available rendition upgrades that fail to meet the minimum rendition upgrade threshold.

50. The system of claim 31, further comprising:
a communication interface at a user terminal comprising the content cache;
wherein at least one rendition of the one or more renditions is received at the communication interface via a forward communication link, and wherein the storage manager stores the at least one rendition in the content cache if the rendition upgrade value for the at least one rendition meets the minimum rendition upgrade threshold and the storage manager does not store the at least one rendition in the content cache if the rendition upgrade value for the at least one rendition fails to meet the minimum rendition upgrade threshold.

51. The system of claim 31, wherein the storage manager is further operative to:
detect an eviction trigger, wherein the storage manager performs content eviction in response to detection of the eviction trigger.

52. The system of claim 51, wherein the eviction trigger comprises a used storage capacity of the content cache satisfying a storage threshold.

53. The system of claim 51, wherein the eviction trigger comprises a periodic temporal trigger.

54. The system of claim 31, wherein the storage manager is further operative to:
establish the minimum rendition upgrade threshold based on an identified amount of storage space to be made available.

55. The system of claim 31, wherein the minimum rendition upgrade threshold is a defined value.

56. The system of claim 31, wherein the storage manager is operative to calculate the rendition upgrade value for a rendition upgrade by:
for a rendition of the one or more renditions, determining a downgrade option relative to the rendition, wherein the rendition relative to the downgrade option comprises the rendition upgrade;
subtracting a downgrade storage utility for the downgrade option from a storage utility of the rendition to calculate the rendition upgrade value for the rendition upgrade;
subtracting a downgrade content size of the downgrade option from a content size of the rendition to calculate the incremental storage size of the rendition upgrade; and
dividing the incremental storage utility of the rendition upgrade by the incremental storage size of the rendition upgrade to calculate the rendition upgrade value.

57. The system of claim 56, wherein the storage manager is further operative to:
iterate the calculation of the by setting the rendition as the downgrade option relative to a higher-resource rendition for a media object.

58. The system of claim 57, wherein the iteration is performed until all renditions of the one or more renditions have been evaluated as the rendition upgrade relative to the downgrade option.

59. The system of claim 56, wherein the downgrade option comprises a null rendition corresponding to no storage of any rendition for a media object.

60. The system of claim 56, wherein the storage manager is further operative to:
find a selected rendition with a maximum rendition upgrade value relative to the downgrade rendition option; and
add the selected rendition to the listing.

61. The system of claim 31, further comprising:
a user terminal comprising the content cache;
wherein the storage manager is located at the user terminal.

62. The system of claim 31, further comprising:
a user terminal comprising the content cache;
wherein the storage manager is located remote from the user terminal.
